(19) United States
(12) Patent Application Publication
(10) Pub. No.: US 2026/0066808 A1
(43) Pub. Date: Mar. 5, 2026

(54) TRANSFORMERS WITH TOP LEAKAGE FLUX PATH FOR POWER CONVERTERS

(71) Applicant: Monolithic Power Systems, Inc., San Jose, CA (US)

(72) Inventor: Ting GE, San Jose, CA (US)

(21) Appl. No.: 19/095,858

(22) Filed: Mar. 31, 2025

Related U.S. Application Data
(63) Continuation-in-part of application No. 18/816,601, filed on Aug. 27, 2024.
(63) Continuation-in-part of application No. 18/816,571, filed on Aug. 27, 2024.

(51) Int. Cl. H02M 7/06; H01F 27/02; H01F 27/24; H01F 38/08; H02M 7/219

(52) U.S. Cl. CPC H02M 7/068; H01F 27/027; H01F 27/24; H01F 38/08; H02M 7/219

(57) ABSTRACT

Disclosed are transformers for power converters. A power converter includes a bridge circuit and a chain of transformer-rectifier (TR) blocks. Each of the TR blocks has a transformer and a rectifier circuit. The transformer has a magnetic core, primary windings that have one or more turns, and secondary windings that are wound a single turn over corresponding primary windings. Leakage flux of the transformer is through a magnetic core that is disposed on top of the windings. The bridge circuit is driven to generate a primary winding current, which flows to the primary windings of the transformers of the TR blocks. Currents induced in the secondary windings are rectified by the rectifier circuits to generate an output current that is provided to a load of the power converter.

### CROSS-REFERENCE TO RELATED APPLICATIONS

This application is a continuation-in-part of U.S. application Ser. No. 18/816,601, filed on Aug. 27, 2024, and a continuation-in-part of U.S. application Ser. No. 18/816,571, filed on Aug. 27, 2024. Both of these related applications are incorporated herein by reference in their entirety.

### TECHNICAL FIELD

The present disclosure is directed generally to electrical circuits, and more particularly to power converters.

### BACKGROUND

A power converter is an electrical circuit that transforms power from one form to another. The demand for compact and efficient power converters has grown significantly with the proliferation of modern electronic devices and systems, ranging from portable gadgets to high-performance data centers. Conventional power converters often face challenges in minimizing their physical footprint while maintaining high efficiency and thermal performance. The need for smaller designs arises from space constraints, particularly in applications such as mobile devices, automotive systems, and artificial intelligence, where maximizing functionality within limited space is critical. Existing solutions typically involve trade-offs between size, power density, and thermal management, highlighting the need for innovative approaches to reduce the overall footprint of power converters without compromising their performance or reliability.

### BRIEF SUMMARY

In one embodiment, a transformer-rectifier block for a power converter comprises a substrate, a transformer, and a rectifier circuit. The transformer has a bottom end that is mounted on the substrate. The transformer comprises a magnetic core, a first primary winding, a first secondary winding that is wound over the first primary winding, a second primary winding, and a second secondary winding that is wound over the second primary winding. The first and second secondary windings are disposed adjacent to each other, and the magnetic core is disposed over portions of the first and second secondary windings that extend toward a top end of the transformer. The rectifier circuit is mounted on the substrate and comprises a first rectifier that is electrically connected to an end of the first secondary winding and a second rectifier that is electrically connected to an end of the second secondary winding.

In another embodiment, a transformer for a power converter comprises a plurality of windings and a magnetic core. The plurality of windings comprises a first primary winding, a first secondary winding that is wound over the first primary winding, a second primary winding, and a second secondary winding that is wound over the second primary winding. The magnetic core is disposed over the first primary winding, the second primary winding, the first secondary winding, and the second secondary winding. The first and second secondary windings are disposed adjacent to each other. The first primary winding, the first secondary winding, the second primary winding, and the second secondary winding extend toward a top end of the transformer into a recess in the magnetic core.

In yet another embodiment, a power converter comprises a bridge circuit and a plurality of transformer-rectifier (TR) blocks. Each of the TR blocks comprises a rectifier and a transformer. The transformer comprises a plurality of windings and a magnetic core that is disposed over the windings. The windings are disposed adjacent to each other and extend toward a top end of the transformer into a recess in the magnetic core. The primary windings of the transformers of the TR blocks are connected in series to receive a current from the bridge circuit, and output currents of the TR blocks flow from the secondary windings of the transformers of the TR blocks to a load.

These and other features of the present disclosure will be readily apparent to persons of ordinary skill in the art upon reading the entirety of this disclosure, which includes the accompanying drawings and claims.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 shows a block diagram of a high step down power converter, in accordance with an embodiment of the present invention.

FIG. 2 shows a schematic diagram of a high-voltage half bridge circuit, in accordance with an embodiment of the present invention.

FIG. 3 shows a schematic diagram of a high-voltage full bridge circuit, in accordance with an embodiment of the present invention.

FIG. 4 shows a schematic diagram of a transformer-rectifier (TR) block, in accordance with an embodiment of the present invention.

FIG. 5 shows a schematic diagram of a TR block, in accordance with an embodiment of the present invention.

FIGS. 6-9 show various views of a transformer of the TR block of FIG. 5, where each of the primary windings has a single turn, in accordance with an embodiment of the present invention.

FIGS. 10-12 show various views of a transformer of the TR block of FIG. 5, where each of the primary windings has a plurality of turns, in accordance with an embodiment of the present invention.

FIG. 13 shows a schematic diagram of a TR block, in accordance with an embodiment of the present invention.

FIGS. 14-16 show various views of a transformer of the TR block of FIG. 13, in accordance with an embodiment of the present invention.

FIG. 17 shows a schematic diagram of a high step down power converter, in accordance with an embodiment of the present invention.

FIGS. 18 and 19 show timing diagrams of the power converter of FIG. 17, in accordance with an embodiment of the present invention.

FIG. 20 shows a schematic diagram of a power converter, in accordance with an embodiment of the present invention.

FIGS. 21 and 22 show timing diagrams of the power converter of FIG. 20, in accordance with an embodiment of the present invention.

FIG. 23 shows a top view of a TR block, in accordance with an embodiment of the present invention.

FIG. 24 shows a top view of a transformer module of the TR block of FIG. 23, in accordance with an embodiment of the present invention.

FIG. 25 shows a top view of a TR block, in accordance with an embodiment of the present invention.

FIG. 26 shows a top view of horizontally disposed TR blocks, in accordance with an embodiment of the present invention.

FIG. 27 shows a front view of a TR block, in accordance with an embodiment of the present invention.

FIG. 28 shows a top view of a rectifier module of the TR block of FIG. 27, in accordance with an embodiment of the present invention.

FIG. 29 shows a top view of a bottom surface of a transformer module of the TR block of FIG. 27, in accordance with an embodiment of the present invention.

FIG. 30 shows a top view of a transformer module of the TR block of FIG. 27, in accordance with an embodiment of the present invention.

FIGS. 31 and 32 show front views of the TR block of FIG. 27, in accordance with an embodiment of the present invention.

FIG. 33 shows a top view of TR blocks, in accordance with an embodiment of the present invention.

FIG. 34 shows a transparent, perspective view of a transformer, in accordance with an embodiment of the present invention.

FIGS. 35 and 36 show perspective views of windings of the transformer of FIG. 34, in accordance with an embodiment of the present invention.

FIGS. 37 and 38 show perspective views of magnetic core portions of the transformer of FIG. 34, in accordance with an embodiment of the present invention.

FIG. 39 shows a schematic diagram of a TR block that incorporates the transformer of FIG. 34, in accordance with an embodiment of the present invention.

FIG. 40 shows a bottom view of the transformer of FIG. 34, in accordance with an embodiment of the present invention.

FIG. 41 shows a schematic diagram of a simulation circuit, in accordance with an embodiment of the present invention.

FIG. 42 shows inductance-current (L-I) curves in a simulation of the simulation circuit of FIG. 41, in accordance with an embodiment of the present invention.

FIG. 43 shows a top view of a TR block that incorporates the transformer of FIG. 34, in accordance with an embodiment of the present invention.

FIGS. 44 and 45 show a schematic diagram of a power converter that incorporates the transformer of FIG. 34, in accordance with an embodiment of the present invention.

FIG. 46 shows a transparent, perspective view of a transformer, in accordance with an embodiment of the present invention.

FIG. 47 shows a perspective view of primary windings and secondary windings of the transformer of FIG. 46, in accordance with an embodiment of the present invention.

FIG. 48 shows a top view of the secondary windings of the transformer of FIG. 46, in accordance with an embodiment of the present invention.

FIGS. 49 and 50 show perspective views of magnetic core portions of the transformer of FIG. 46, in accordance with an embodiment of the present invention.

FIG. 51 shows a schematic diagram of a TR block, in accordance with an embodiment of the present invention.

FIG. 52 shows a bottom view of the transformer of FIG. 46, in accordance with an embodiment of the present invention.

### DETAILED DESCRIPTION

In the present disclosure, numerous specific details are provided, such as examples of circuits, components, structures, materials, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

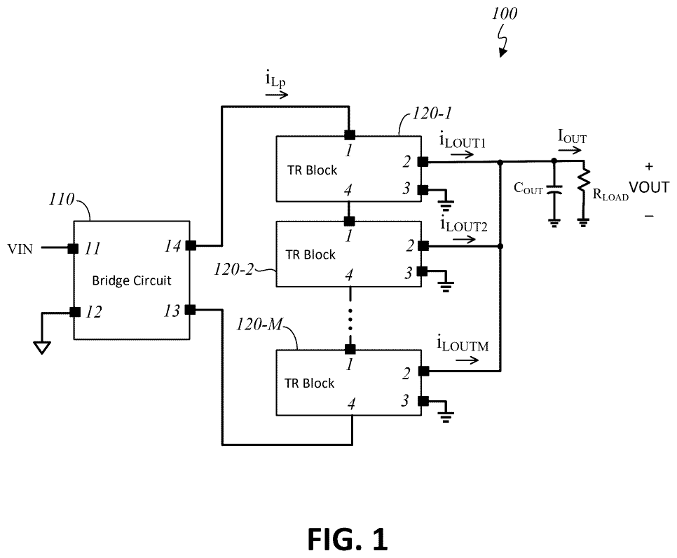

FIG. 1 shows a block diagram of a high step down step down power converter 100, in accordance with an embodiment of the present invention. The power converter 100 converts a DC input voltage VIN to a regulated DC output voltage VOUT. The power converter 100 is a high step down power converter in that the ratio of the input voltage VIN to the output voltage VOUT is relatively high. In one embodiment, the input voltage VIN is 48V and the output voltage VOUT is 1V. The output voltage VOUT is developed across a load, which is represented by a load resistor R_{LOAD}. The load may be a Graphics Processing Unit (GPU), Central Processing Unit (CPU), or other electrical circuit. An output capacitor COUT is across the load resistor R_{LOAD}.

In the example of FIG. 1, the power converter 100 comprises a high-voltage bridge circuit 110 and a plurality of transformer-rectifier (TR) blocks 120 (i.e., 120-1, 120-2, . . . , 120-M). The bridge circuit 110 may be a half bridge circuit or full bridge circuit. A TR block 120 comprises a transformer and a rectifier circuit. The transformer and the rectifier circuit may be implemented as a single, integrated module or as separate, discrete modules (e.g., as a transformer module and a separate rectifier module). A transformer module or rectifier module is a self-contained discrete unit that can be easily integrated into a more complex system, such as a power supply. A transformer module and a rectifier module may be disposed horizontally side by side on a substrate or disposed vertically one on top of the other.

The power converter 100 is scalable in that TR blocks 120 may be added to or removed from the power converter 100 to meet the requirements of a specific application. In the example of FIG. 1, the TR blocks 120 are connected to provide the output voltage VOUT. TR blocks 120 may be added or removed to increase or decrease the output current I_{OUT} of the power converter 100.

In the example of FIG. 1, a TR block 120 includes a node 1 that is connected to one end of a primary winding of a transformer, a node 2 that is connected to the output voltage VOUT, a node 3 that is connected to ground, and a node 4 that is connected to the other end of the primary winding of the transformer. The primary windings of the transformers of the TR blocks 120 are connected in series by connecting a node 4 of a TR block 120 to a node 1 of the next TR block 120 to form a chain of TR blocks 120.

In the example of FIG. 1, the bridge circuit 110 includes a node 11 that receives the input voltage VIN, a node 12 that is connected to ground, a node 13 that is connected to a node 4 of a TR block 120 at one end of the chain of TR blocks, and a node 14 that is connected to a node 1 of a TR block 120 at the other end of the chain of TR blocks. The ground of the bridge circuit 110 (at node 12) and the ground of the TR blocks 120 (at node 3) may be tied together or isolated depending on the application.

In the example of FIG. 1, the bridge circuit 110 converts the DC input voltage VIN to an AC current i_{Lp} that flows directly to the TR block 120-1, instead of to an intermediate circuit stage between the half bridge circuit 110 and the TR blocks 120. This design eliminates the need to develop an intermediate bus voltage, thereby reducing parts count by removing the bus voltage capacitor and transistors of the intermediate circuit stage. The current i_{Lp} from the bridge circuit 110 flows to the series-connected primary windings of transformers of the TR blocks 120. Currents induced in the secondary windings of the transformers are rectified by corresponding TR blocks 120 to generate rectified output currents i_{LOUT} (i.e., i_{LOUT1}, i_{LOUT2}, . . . , i_{LOUTM}) that flow to the load. The rectified output currents i_{LOUT} of the TR blocks 120 collectively form the output current i_{OUT} of the power converter 100, which is delivered to the load.

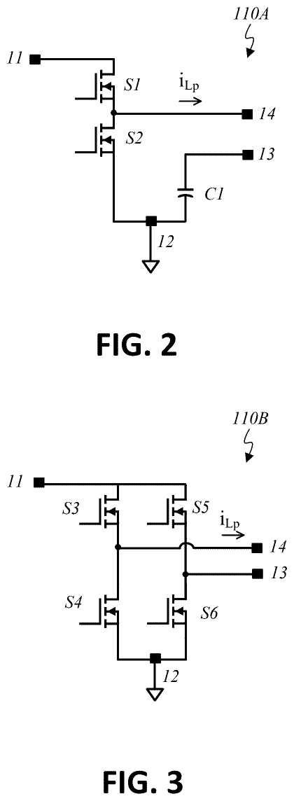

FIG. 2 shows a schematic diagram of a high-voltage half bridge circuit 110A, in accordance with an embodiment of the present invention. The bridge circuit 110A is a half bridge embodiment of the bridge circuit 110 of FIG. 1. In the example of FIG. 2, the half bridge circuit 110A comprises a switch S1, a switch S2, and a capacitor C1. The switch S1 has a first end that is connected to the node 11 and a second end that is connected to a first end of the switch S2. The current i_{Lp} flows from a bridge node that is formed by the second end of the switch S1 and the first end of the switch S2 at the node 14. The capacitor C1 has a first end that is connected to the node 13 and a second end that is connected to ground at the node 12.

FIG. 3 shows a schematic diagram of a high-voltage full bridge circuit 110B, in accordance with an embodiment of the present invention. The bridge circuit 110B is a full bridge embodiment of the bridge circuit 110 of FIG. 1. In the example of FIG. 3, the full bridge circuit 110B comprises switches S3-S6. The switch S3 has a first end that is connected to the node 11 and a second end that is connected to a first end of the switch S4. The switch S4 has a second end that is connected to ground at the node 12. The switch S5 has a first end that is connected to the node 11 and a second end that is connected to a first end of the switch S6. The switch S6 has a second end that is connected to ground at the node 12. The second end of the switch S3 and the first end of the switch S4 form a first bridge node at the node 14, from which the current i_{Lp} flows. The second end of the switch S5 and the first end of the switch S6 form a second bridge node that is connected to the node 13.

In the example of FIGS. 2 and 3, each of the switches S1-S6 is a Metal-Oxide-Semiconductor Field-Effect Transistor (MOSFET), the first end of each of the switches S1-S6 is a drain, and the second end of each of the switches S1-S6 is a source. A control end of each of the switches S1-S6 is a gate, which may receive a corresponding signal in accordance with a control scheme (e.g., pulse width modulation (PWM)) to control the operation of the power converter 100 of FIG. 1 to generate a regulated output voltage VOUT. As can be appreciated other suitable types of transistors may also be employed.

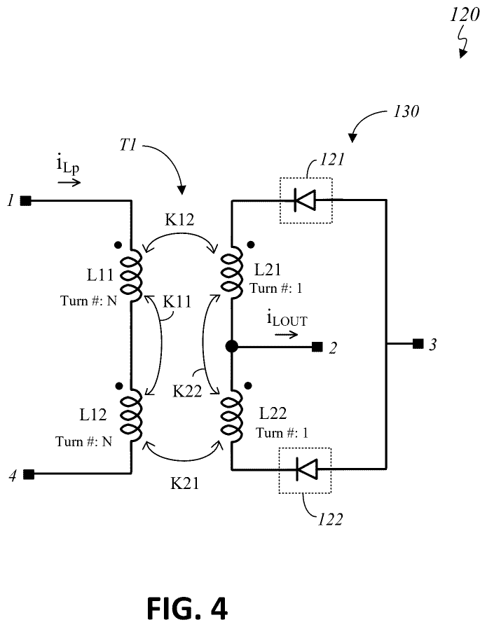

FIG. 4 shows a schematic diagram of a TR block 120, in accordance with an embodiment of the present invention. In one embodiment, the TR block 120 comprises a transformer T1 and a rectifier circuit 130. The transformer T1 has primary windings L11 and L12 and secondary windings L21 and L22. The primary windings L11 and L12 are connected in series. Each of the windings L11, L12, L21, and L22 may comprise a flat copper wire, for example. The current i_{Lp} from the bridge circuit 110 or previous TR block 120 in a chain of TR blocks 120 enters the node 1, flows to the primary windings L11 and L12, and exits from node 4 to flow to the bridge circuit 110 or next TR block 120 in the chain of TR blocks 120.

In one embodiment, the turns ratio between the primary and secondary windings is N:1. That is, the primary winding L11 has N turns and the corresponding secondary winding L21 has 1 turn. Similarly, the primary winding L12 has N turns and the corresponding secondary winding L22 has 1 turn. The phase relationships between voltage and current in the primary winding L11 and secondary winding L21 and in the primary winding L12 and secondary winding L22 are as per the dot convention shown in FIG. 4.

In the example of FIG. 4, K12 is the coefficient of coupling between the primary winding L11 and the secondary winding L21; K21 is the coefficient of coupling between the primary winding L12 and the secondary winding L22; K11 is the coefficient of coupling between the primary windings L11 and L12; and K22 is the coefficient of coupling between the secondary windings L21 and L22. The relationships between the coupling coefficients are,

$$K 12 = K 21 > 0 ; K 11 = K 22 ; and K 22 \geq 0 or K 22 \leq 0.$$

The primary winding L11 has a first end that is connected to the node 1 and a second end that is connected to a first end of the primary winding L12.

In the example of FIG. 4, the rectifier circuit 130 comprises a rectifier 121 and a rectifier 122. Each of the rectifiers 121 and 122 may comprise a MOSFET or other switch. The rectifiers 121 and 122 are configured as synchronous rectifiers, but are represented by their body diodes in FIG. 4 for ease of illustration. The secondary winding L21 has a first end that is connected to a first end of the rectifier 121 and a second end that is connected to a first end of the secondary winding L22. The second end of the secondary winding L22 is connected to a first end of the rectifier 122. The second end of the secondary winding L21 and the first end of the secondary winding L22 form a rectifier output node that is connected to the node 2. The second ends of the rectifiers 121 and 122 are both connected to the node 3. The output current i_{LOUT} of the rectifier 120 flows to the load by way of the node 2.

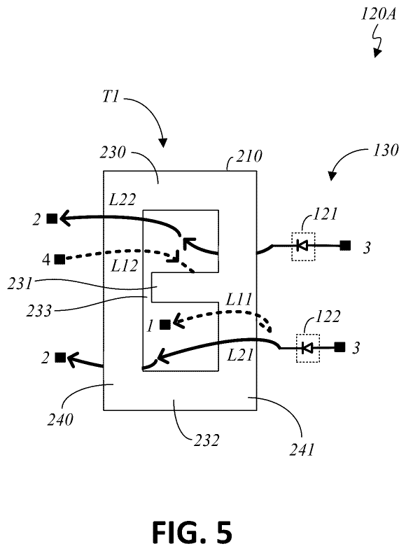

FIG. 5 shows a schematic diagram of a TR block 120A, in accordance with an embodiment of the present invention. The TR block 120A is a particular embodiment of the TR block 120 of FIG. 4 where,

$$K 12 = K 21 > 0 ; K 11 = K 22 ; and K 22 \geq 0.$$

The TR block 120A comprises the transformer T1 and the rectifier circuit 130. In the example of FIG. 5, the transformer T1 comprises the primary windings L11 and L12, secondary windings L21 and L22, and a magnetic core 210.

In the example of FIG. 5, the magnetic core 210 has a plurality of bar portions that are arranged in rectangular fashion comprising legs 230-232 that are along the short side, and yokes 240 and 241 that are along the long side. The legs 230 and 232 are connected to both of the opposing yokes 240 and 241. The leg 231, which is between the legs 230 and 232, is connected to only one of the yokes (the yoke 241). In other words, there is an air gap 233 between the leg 231 and the yoke 240. The air gap 233 helps prevent saturation. Small gaps may also exist in yokes 240 and 241 and in legs 230 and 232 to avoid saturation; however these gaps are shorter than the air gap 233.

The magnetic core 210 may be a single-piece or multipiece core that is made of a magnetic material that is commonly-used in magnetic cores. For example, the yoke 240, yoke 241, leg 230, leg 231, and leg 232 may be made of a single piece of magnetic material. As another example, one or more of the yokes 240, yoke 241, leg 230, leg 231, and leg 232 may be separate pieces of magnetic material.

In the example of FIG. 5, the primary winding L12 (depicted as a dash line) starts at the node 4, winds around the yoke 240 between the legs 230 and 231 one or more turns, then goes under the yoke 241 to form the primary winding L11. The primary winding L11 winds around the yoke 241 between the legs 231 and 232 one or more turns, then connects to the node 1. The secondary winding L21 starts at the first end (cathode in FIG. 5) of the rectifier 122, goes over the yoke 241 to make a single turn around the yoke 241, and goes under the yoke 240 to connect to the node 2. The secondary winding L22 starts at the first end (cathode in FIG. 5) of the rectifier 121, goes under the yoke 241, and goes over the yoke 240 to wind a single turn around the yoke 240 to connect to the node 2. The second ends (anode in FIG. 5) of the rectifiers 121 and 122 are connected to the node 3.

In the example of FIG. 5, it is to be noted that the primary winding L11 and the secondary winding L21 wind around the yoke 241, whereas the primary winding L12 and the secondary winding L22 wind around the yoke 240. That is, the primary/secondary winding pairs wind around opposing yokes.

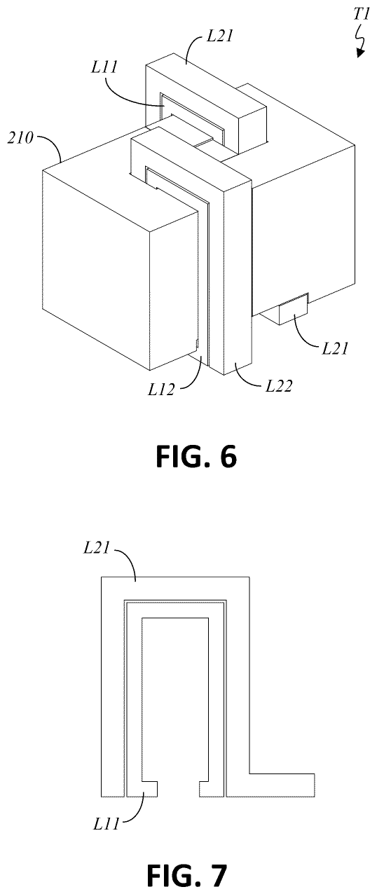

FIGS. 6-9 show various views of the transformer T1, where each of the primary windings L11 and L12 has a single turn, in accordance with an embodiment of the present invention. In the example of FIGS. 6-9, each of the primary windings L11 and L12 is wound 1 turn, and each of the secondary windings L21 and L22 is wound 1 turn. In the example of FIGS. 6-9, the primary winding L11, primary winding L12, secondary winding L21, and secondary winding L22 are flat copper wires with enamel coating and have the same widths. Generally, primary and secondary windings disclosed herein may be insulated using materials or insulation structures that are available in the transformer industry.

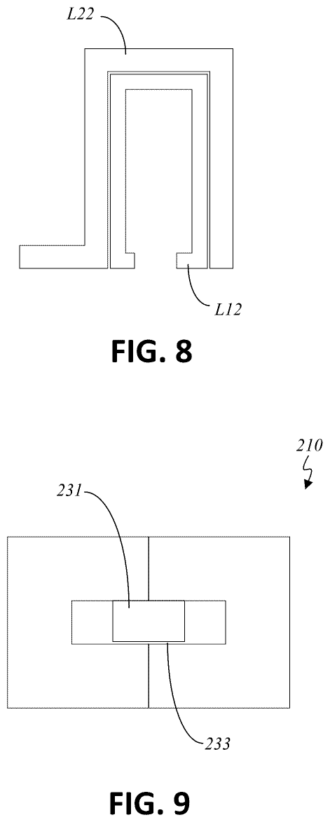

FIG. 6 shows a perspective view of the transformer T1. To improve heat dissipation, the secondary winding L21 is wound over the primary winding L11 and the secondary winding L22 is wound over the primary winding L12. Heatsink and thermal interface material may be disposed on top of the secondary windings L21 and L22 to help improve heat dissipation. FIG. 7 shows a side view of the primary winding L11 and the secondary winding L21. FIG. 8 shows a side view of the primary winding L12 and the secondary winding L22. FIG. 9 shows a top view of the magnetic core 210, illustrating the air gap 233 between the leg 231 and a yoke of the magnetic core 210.

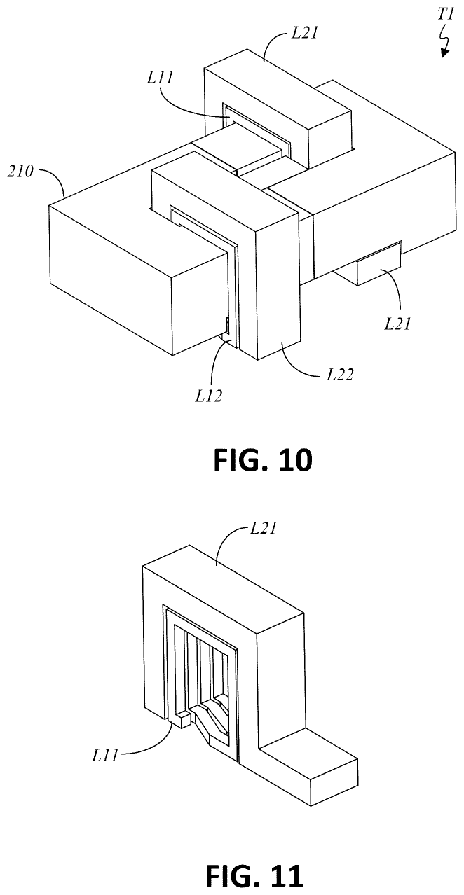

FIGS. 10-12 show various views of the transformer T1, where each of the primary windings L11 and L12 has a plurality of turns, in accordance with an embodiment of the present invention. In the example of FIGS. 10-12, each of the primary windings L11 and L12 is wound a plurality of turns, and each of the secondary windings L21 and L22 is wound 1 turn. In the example of FIGS. 10-12, the primary winding L11, primary winding L12, secondary winding L21, and secondary winding L22 are flat copper wires with enamel coating, and the primary windings L11 and L12 are narrower than the secondary windings L21 and L22.

FIG. 10 shows a perspective view of the transformer T1. As before, the secondary winding L21 is wound over the primary winding L11 and the secondary winding L22 is wound over the primary winding L12 to improve heat dissipation.

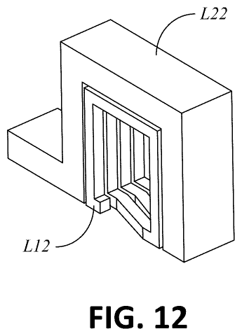

FIG. 11 shows a perspective view of the primary winding L11 and the secondary winding L21, and FIG. 12 shows a perspective view of the primary winding L12 and the secondary winding L22. FIGS. 11 and 12 illustrate the multiple turns of the primary windings L11 and L12, which are narrower than the secondary windings L21 and L22, respectively.

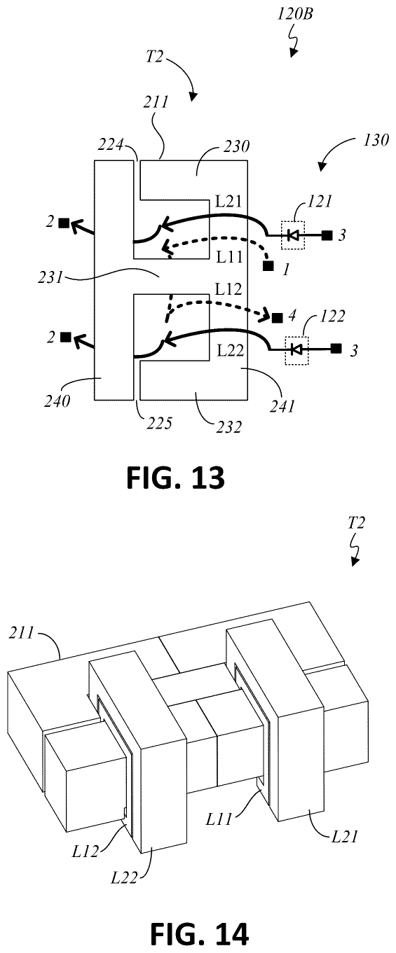

FIG. 13 shows a schematic diagram of a TR block 120B, in accordance with an embodiment of the present invention. The TR block 120B is a particular embodiment of the TR block 120 of FIG. 4 where,

$$K 12 = K 21 > 0 ; K 11 = K 22 ; and K 22 \leq 0.$$

The TR block 120B comprises a transformer T2 and the rectifier circuit 130. The transformer T2 is a particular embodiment of the transformer T1. The transformer T2 comprises the primary windings L11 and L12, secondary windings L21 and L22, and a magnetic core 211.

Similar to the magnetic core 210 of the transformer T1, the magnetic core 211 has a plurality of bar portions that are arranged in rectangular fashion comprising legs 230-232 on the short side, and yokes 240 and 241 on the long side. In the case of the magnetic core 211, the leg 231 is connected to both of the opposing yokes 240 and 241, whereas each of the legs 230 and 232 is connected to only one yoke. In the magnetic core 211, there is an air gap 224 between the leg 230 and the yoke 240, and there is an air gap 225 between the leg 232 and the yoke 240. The air gaps 224 and 225 help prevent saturation.

The magnetic core 211 may be a single-piece or multipiece core that is made of a magnetic material that is commonly-used in magnetic cores. For example, the yoke 240, yoke 241, leg 230, leg 231, and leg 232 may be made of a single piece of magnetic material. As another example, one or more of the yoke 240, yoke 241, leg 230, leg 231, and leg 232 may be separate pieces of magnetic material.

In the example of FIG. 13, the primary winding L11 (depicted as a dash line) starts at the node 1, winds around the yoke 241 between the legs 230 and 231 one or more turns, goes under the leg 231, then goes over the yoke 241 to form the primary winding L12. The primary winding L12 winds around the yoke 241 between the legs 231 and 232 one or more turns, then connects to the node 4. The secondary winding L21 starts at the first end (cathode in the example of FIG. 13) of the rectifier 121, goes over the yoke 241 to wound a single turn around the yoke 241, then goes under the yoke 240 to connect to the node 2. The secondary winding L22 starts at the first end (cathode in the example of FIG. 13) of the rectifier 122, goes over the yoke 241 to wind around the yoke 241 a single turn, then goes under the yoke 240 to connect to the node 2. The second ends (anode in the example of FIG. 13) of the rectifiers 121 and 122 are connected to the node 3.

In the example of FIG. 13, it is to be noted that the primary winding L11, the secondary winding L21, the primary winding L12, and the secondary winding L22 wind around the yoke 241. That is, all of the primary/secondary winding pairs wind around the same yoke. This is in contrast to the example of FIG. 5, where the primary/secondary winding pairs wind around opposing yokes.

FIGS. 14-16 show various views of the transformer T2, in accordance with an embodiment of the present invention. In the example of FIGS. 14-16, each of the primary windings L11 and L12 is wound 1 turn, and each of the secondary windings L21 and L22 is wound 1 turn. In the example of FIGS. 14-16, the primary winding L11, primary winding L12, secondary winding L21, and secondary winding L22 are flat copper wires with enamel coating and have the same widths.

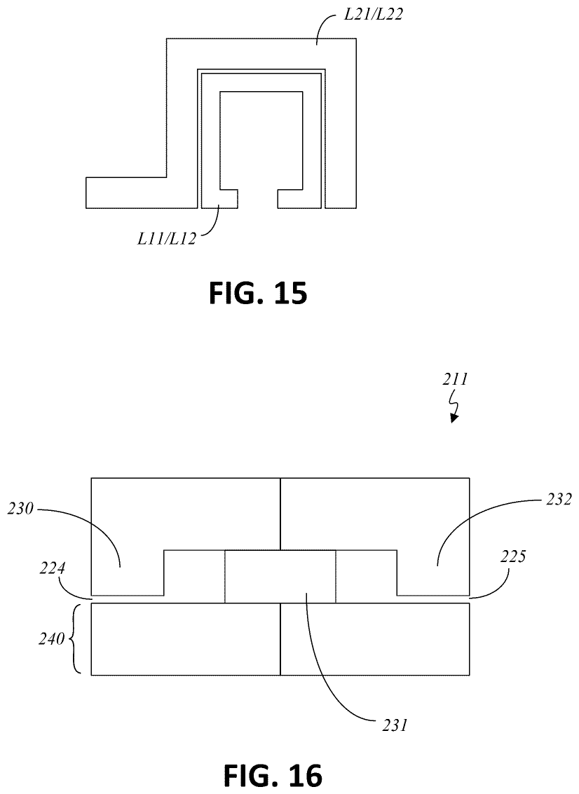

FIG. 14 shows a perspective view of the transformer T2. To improve heat dissipation, the secondary winding L21 is wound over the primary winding L11 and the secondary winding L22 is wound over the primary winding L12. FIG. 15 shows a side view that illustrates the secondary winding L21/L22 over the primary winding L11/L12. FIG. 16 shows a top view of the magnetic core 211, which illustrates the air gap 224 between the leg 230 and the yoke 240 and the air gap 225 between the leg 232 and the yoke 240. In the magnetic core 211, only the leg 231 is connected to both of the opposing yokes. An air gap may also exist between the leg 231 and the yoke 240, but its gap length is narrower than that of the air gaps 224 and 225.

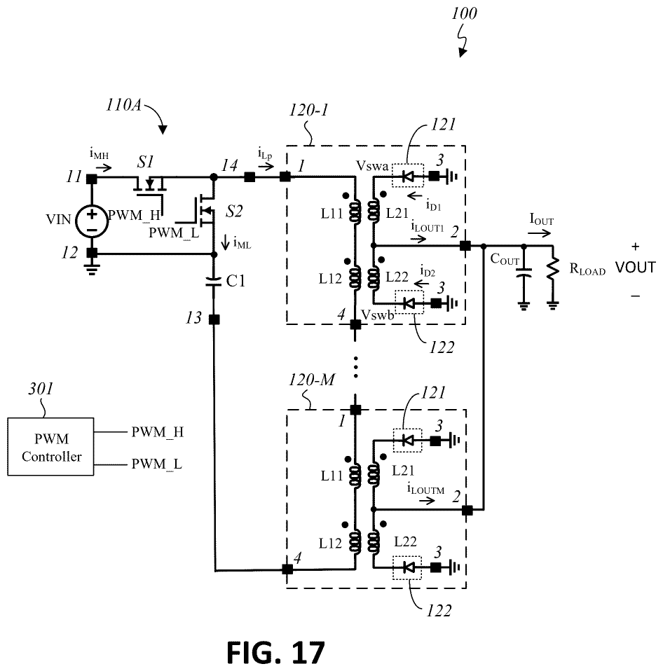

FIG. 17 shows a schematic diagram of the power converter 100 of FIG. 1, in accordance with an embodiment of the present invention. FIG. 17 illustrates a particular embodiment of the power converter 100. In the example of FIG. 17, the power converter 100 comprises the half bridge circuit 110A (also shown in FIG. 2) and a plurality of TR blocks 120. The nodes 11-14 of the half bridge circuit 110A and the nodes 1-4 of each of the TR blocks 120 are connected as in FIG. 1.

In the example of FIG. 17, a PWM controller 301 generates a PWM_H signal that is provided to the control end of the switch S1 and a PWM_L signal that is provided to the control end of the switch S2. The PWM controller 301 may generate the PWM_H and PWM_L signals in accordance with a suitable PWM control scheme, such as by symmetric half bridge control (SHB) or asymmetric half bridge (AHB) control.

The following signals are shown in FIG. 17: (a) a current i_{MH} flowing from the node 11 to the node 14 through the switch S1; (b) the current i_{Lp} flowing from the node 14 to the node 1 of the TR block 120-1; (c) a current i_{ML} flowing through the switch S2 to ground; and (d) an output current I_{OUT} flowing to the load represented by the resistor R_{LOAD}. Note that in the example of FIG. 17, the current i_{Lp} flows directly to the TR block 120-1, instead of to an intermediate circuit stage between the half bridge circuit 110A and the TR block 120-1.

FIG. 17 further shows the following signals that are in each TR block 120: (a) a voltage Vswa between a first end of the secondary winding L21 and a first end of the rectifier 121; (b) a current i_{D1} flowing to the secondary winding L21 through the rectifier 121; (c) a voltage Vswb between a second end of the secondary winding L22 and a first end of the rectifier 122; a current i_{D2} flowing to the secondary winding L22 through the rectifier 122; and a current i_{LOUT} flowing to the load. Note that the output currents i_{LOUT} of the TR blocks 120 (i.e., i_{LOUT1}, . . . , i_{LOUTM}) add up to provide the overall output current I_{OUT} of the power converter 100.

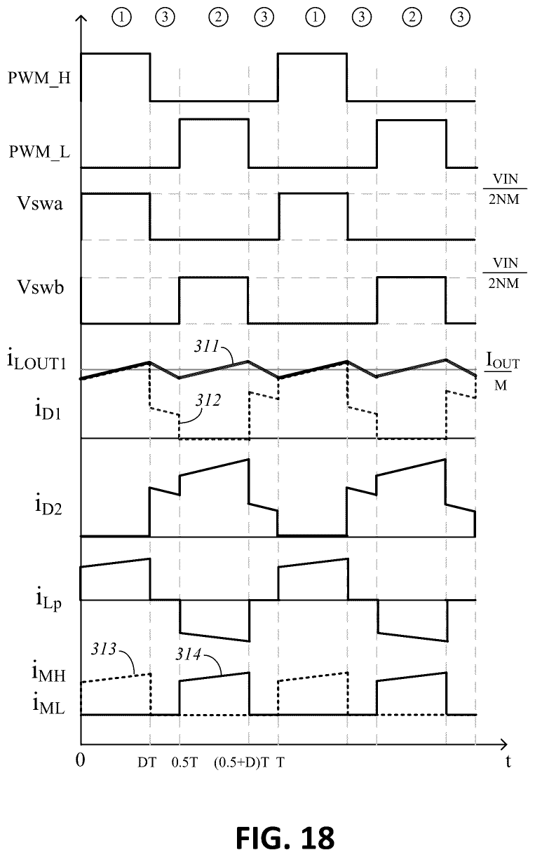

FIG. 18 shows a timing diagram of the power converter 100, in accordance with an embodiment of the present invention. In the example of FIG. 18, the circled numbers on top of the diagram represent repeated phases, and the horizontal axis represents time.

In the example of FIG. 18, the PWM controller 301 generates the control signals PWM_H and PWM_L in accordance with a symmetric half bridge control scheme. The control signals PWM_H and PWM_L are symmetric in that they have the same duty cycle or ON time, and have 180 degree phase shift. The signals shown in FIG. 18 are shown in FIG. 17 and include those of the TR block 120-1. The signals for the other TR blocks 120 are essentially the same as in the TR block 120-1. For convenience of the reader, the current i_{LOUT} is also labeled as 311, the current i_{D1} is also labeled as 312, the current i_{MH} is also labeled as 313, and the current i_{ML} is also labeled as 314.

For symmetric half bridge control as in the example of FIG. 18, the output voltage VOUT of the power converter 100 is given by:

$${V}_{o u t} = \frac{D {V}_{i n}}{2 N M}$$

where D is the duty cycle of the control signals PWM_H and PWM_L, VIN is the input voltage, N is the number of turns of the primary windings L11 and L12, and M is the number of TR blocks 120.

In an example operation, referring to FIGS. 17 and 18, the DC input voltage VIN is received by the half bridge circuit 110A. The half bridge circuit 110A is driven by pulse width modulation (PWM) (see PWM_H, PWM_L) to generate a primary winding current (see current i_{Lp}). The primary winding current flows from the half bridge circuit 110A to a plurality of primary windings that are connected in series. The primary winding current induces a plurality of secondary winding currents in a plurality of secondary windings that are magnetically coupled to corresponding primary windings of the plurality of primary windings. The plurality of secondary winding currents are rectified to generate a plurality of output currents (see output current i_{LOUT}) that are provided to a load of the power converter (see output current I_{OUT}).

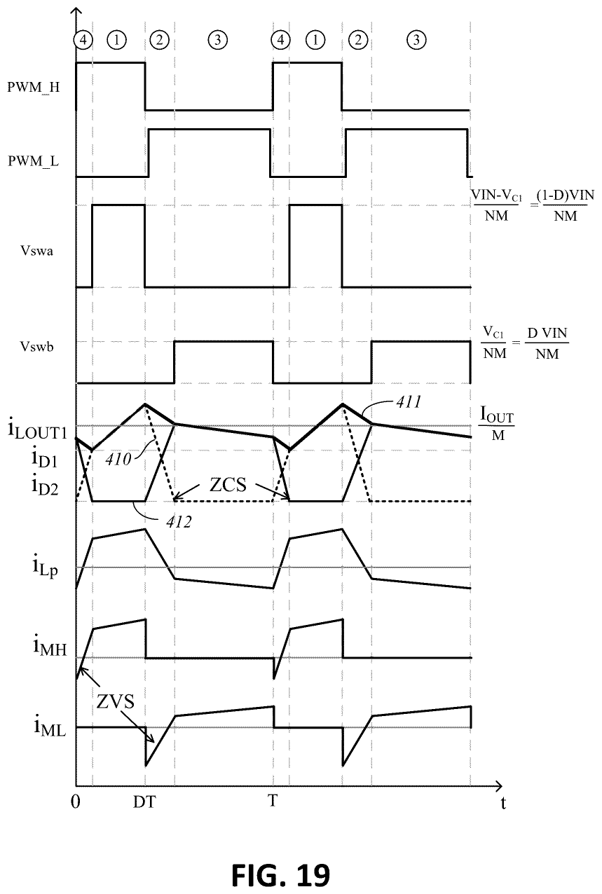

FIG. 19 shows a timing diagram of the power converter 100, in accordance with an embodiment of the present invention. In the example of FIG. 19, the circled numbers on top of the diagram represent repeated phases and the horizontal axis represents time.

In the example of FIG. 19, the PWM controller 301 generates the control signals PWM_H and PWM_L in accordance with an asymmetric half bridge control scheme. The control signals PWM_H and PWM_L are asymmetric in that they have different duty cycles and their currents i_{MH} and i_{ML} are different; in the example of FIG. 19, the control signals PWM_H and PWM_L are complementary. The signals shown in FIG. 19 are as shown in FIG. 17 and include those of the TR block 120-1. The signals for the other TR blocks 120 are essentially the same as in the TR block 120-1. For convenience of the reader, the current i_{LOUT1} is also labeled as 411, the current i_{D1} is also labeled as 410, and the current i_{D2} is also labeled as 412. The arrows “ZCS” indicate points of zero-current switching, and the arrows “ZVS” indicate points of zero-voltage switching.

For asymmetric half bridge control as in the example of FIG. 19, the output voltage VOUT of the power converter 100 is given by:

$${V}_{o u t} = \frac{D ( 1 - D ) {V}_{i n}}{N M}$$

where D is the duty cycle of the control signals PWM_H and PWM_L, VIN is the input voltage, N is the number of turns of the primary windings L11 and L12, and M is the number of TR blocks 120.

The operation of the power converter 100 in the case of FIG. 19 is similar to that in the case of FIG. 18, except for some variations that are due to the asymmetric half bridge PWM control of the half bridge circuit 110A. The processing of the input voltage VIN by the half bridge circuit 110A, generation of the primary winding current by the half bridge circuit 110A, flowing of the primary winding current from the half bridge circuit 110A to the primary windings to induce secondary winding currents in the secondary windings, and rectifying the secondary winding currents to generate output currents that are provided to the load of the power converter 100 are similar to those in the example of FIG. 18.

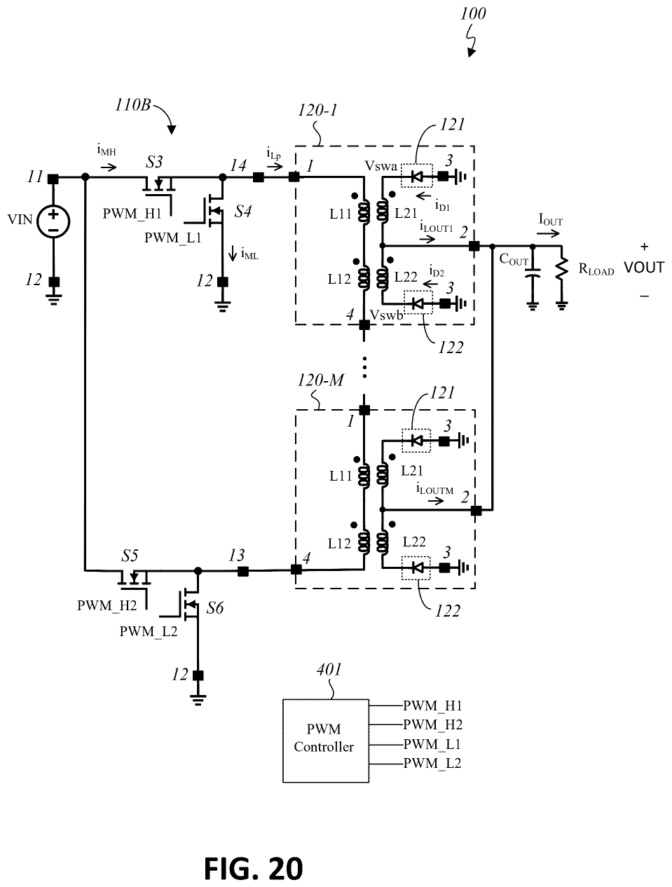

FIG. 20 shows a schematic diagram of the power converter 100 of FIG. 1, in accordance with an embodiment of the present invention. FIG. 20 illustrates a particular embodiment of the power converter 100. In the example of FIG. 20, the power converter 100 comprises the full bridge circuit 110B (also shown in FIG. 3) and a plurality of TR blocks 120. The nodes 11-14 of the full bridge circuit 110B and the nodes 1-4 of the TR blocks 120 are connected as in FIG. 1. The signals shown in FIG. 20 are as described with reference to FIG. 17, except that the current i_{MH} flows to the node 14 through the switch S3 (instead of through the switch S1) and the current i_{ML} flows to ground through the switch S4 (instead of through the switch S2).

In the example of FIG. 20, a PWM controller 401 generates a PWM_H1 signal that is provided to the control end of the switch S3, a PWM_L1 signal that is provided to the control end of the switch S4, a PWM_H2 signal that is provided to the control end of the switch S5, and a PWM_L2 signal that is provided to the control end of the switch S6. The PWM controller 301 may generate the control signals PWM_H1, PWM_H2, PWM_L1, and PWM_L2 in accordance with a suitable PWM control scheme, such as by symmetric full bridge control (SFB) or phase shift full bridge (PSFB) control.

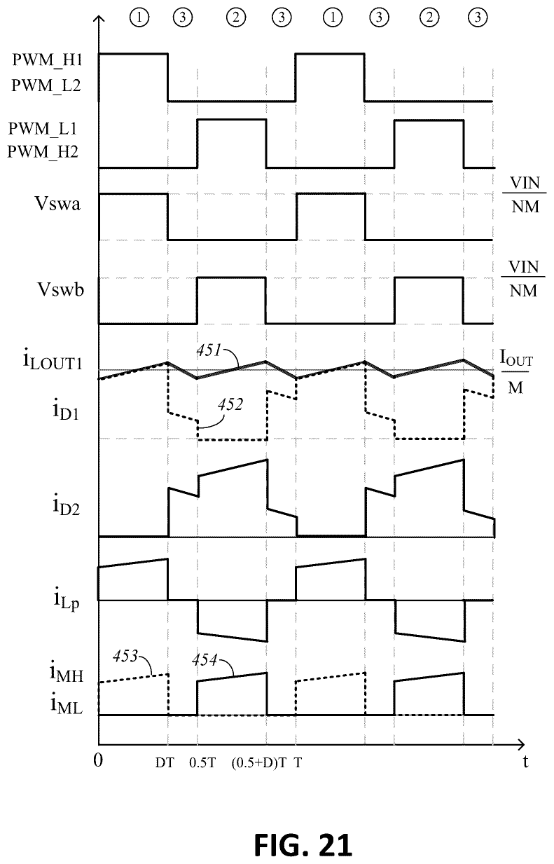

FIG. 21 shows a timing diagram of the power converter 100, in accordance with an embodiment of the present invention. In the example of FIG. 21, the circled numbers on top of the diagram represent repeated phases, and the horizontal axis represents time.

In the example of FIG. 21, the PWM controller 401 generates the control signals PWM_H1, PWM_H2, PWM_L1, and PWM_L2 in accordance with a symmetric full bridge control scheme. The control signals PWM_H1 and PWM_L1 are symmetric in that they have the same duty cycle and with 180 degree phase shift. Similarly, the control signals PWM_H2 and PWM_L2 are symmetric. Note that the control signals PWM_H1 and PWM_L2 are in-phase, and the control signals PWM_H2 and PWM_L1 are also in-phase.

The signals shown in FIG. 21 are shown in FIG. 20 (and FIG. 17) and include those of the TR block 120-1. The signals for the other TR blocks 120 are essentially the same as in the TR block 120-1. For convenience of the reader, the current i_{LOUT} is also labeled as 451, the current i_{D1} is also labeled as 452, the current i_{MH} is also labeled as 453, and the current i_{ML} is also labeled as 454.

For symmetric full bridge control as in the example of FIG. 21, the output voltage VOUT of the power converter 100 is given by:

$${V}_{o u t} = \frac{D {V}_{i n}}{N M}$$

where D is the duty cycle of the control signals PWM_H1, PWM_H2, PWM_L1, and PWM_L2, VIN is the input voltage, N is the number of turns of the primary windings L11 and L12, and M is the number of TR blocks 120.

The operation of the power converter 100 in the case of FIG. 21 is similar to that in the case of FIG. 18, except for some variations that are due to the symmetric full bridge PWM control of the full bridge circuit 110B. The processing of the input voltage VIN by the full bridge circuit 110B, generation of the primary winding current by the full bridge circuit 110B, flowing of the primary winding current from the full bridge circuit 110B to the primary windings to induce secondary winding currents in the secondary windings, and rectifying the secondary winding currents to generate output currents that are provided to the load of the power converter 100 are similar to those in the example of FIG. 18.

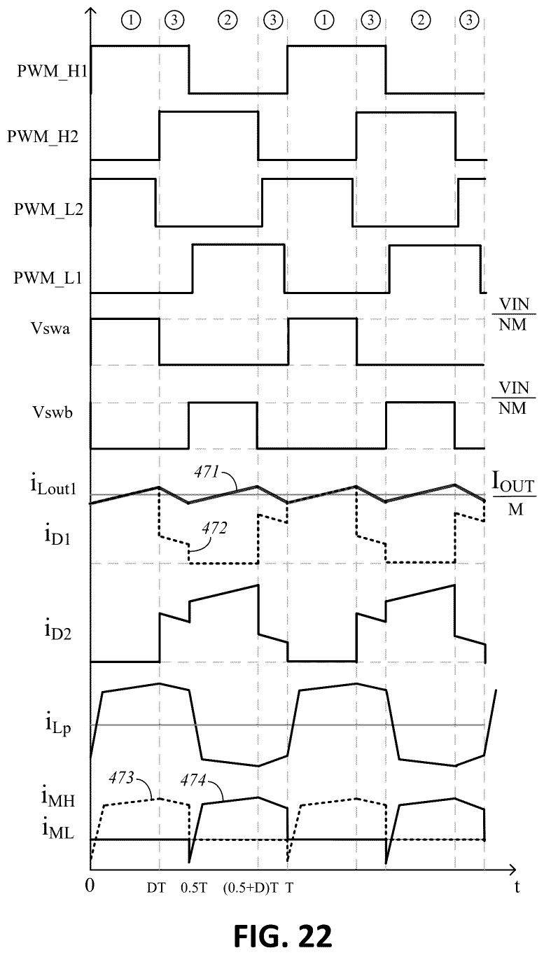

FIG. 22 shows a timing diagram of the power converter 100, in accordance with an embodiment of the present invention. In the example of FIG. 22, the circled numbers on top of the diagram represent repeated phases, and the horizontal axis represents time.

In the example of FIG. 22, the PWM controller 401 generates the control signals PWM_H1, PWM_H2, PWM_L1, and PWM_L2 in accordance with a phase shift full bridge control scheme. Note that in phase shift full bridge control scheme of FIG. 22, the control signals PWM_H1, PWM_H2, PWM_L1, and PWM_L2 have a fixed duty cycle of about 50%; the control signals PWM_H1 and PWM_L1 are complementary; the control signals PWM_H2 and PWM_L2 are complementary; and the output voltage VOUT is regulated by controlling the phase shift between the control signal PWM_H1 and control signal PWM_H2. The signals shown in FIG. 22 are shown in FIG. 20 (and FIG. 17) and include those of the TR block 120-1. The signals for the other TR blocks 120 are essentially the same as in the TR block 120-1. For convenience of the reader, the current i_{LOUT} is also labeled as 471, the current i_{D1} is also labeled as 472, the current i_{MH} is also labeled as 473, and the current i_{ML} is also labeled as 474.

For phase shift full bridge control as in the example of FIG. 22, the output voltage VOUT of the power converter 100 is given by:

$${V}_{o u t} = \frac{D {V}_{i n}}{N M}$$

where D is the duty cycle of the control signals PWM_H1, PWM_H2, PWM_L1, and PWM_L2, VIN is the input voltage, N is the number of turns of the primary windings L11 and L12, and M is the number of TR blocks 120.

The operation of the power converter 100 in the case of FIG. 22 is similar to that in the case of FIG. 18, except for some variations that are due to the phase shift full bridge PWM control of the full bridge circuit 110B. The processing of the input voltage VIN by the full bridge circuit 110B, generation of the primary winding current by the full bridge circuit 110B, flowing of the primary winding current from the full bridge circuit 110B to the primary windings to induce secondary winding currents in the secondary windings, and rectifying the secondary winding currents to generate output currents that are provided to the load of the power converter 100 are similar to those in the example of FIG. 18.

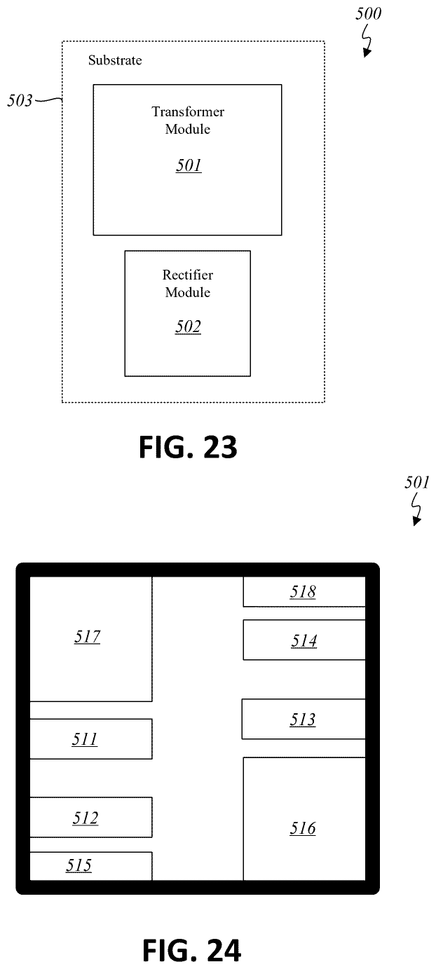

FIG. 23 shows a top view of a TR block 500, in accordance with an embodiment of the present invention. In the example of FIG. 23, the TR block 500 comprises a transformer module 501 and a rectifier module 502 that are disposed horizontally side by side on a surface of a substrate 503. Each of the transformer module 501 and rectifier module 502 is packaged as a single discrete unit. The transformer module 501 and the rectifier module 502 are mounted on a surface of the substrate 503, which may be a printed circuit board (PCB), for example. In one embodiment, the transformer module 501 comprises the previously described transformer T1 or T2, and the rectifier module 502 comprises the previously described rectifier circuit 130. The transformer module 501 and the rectifier module 502 are deployed as a pair to form a TR block 500. A plurality of TR blocks 500 may be mounted on the same substrate 503 or on separate substrates 503.

FIG. 24 shows a top view of the transformer module 501, in accordance with an embodiment of the present invention. The transformer module 501 includes pads 511-518 for making electrical connections as in FIGS. 1-4. In the example of FIG. 24, the pad 511 is connected to the node 1, which is connected to an end of the series-connected primary windings L11 and L12; the pad 514 is connected to the node 4, which is connected to the other end of the series-connected primary windings L11 and L12; the pads 512 and 513 are intermediate points for electrically connecting the primary winding L12 to the primary winding L11; the pad 515 connects to the first end of the rectifier 121; the pad 516 connects to the first end of the rectifier 122; and the pads 517 and 518 connect to the output voltage VOUT. As can be appreciated, the pad layout of the transformer module 501 may be varied to meet the requirements of the particular application.

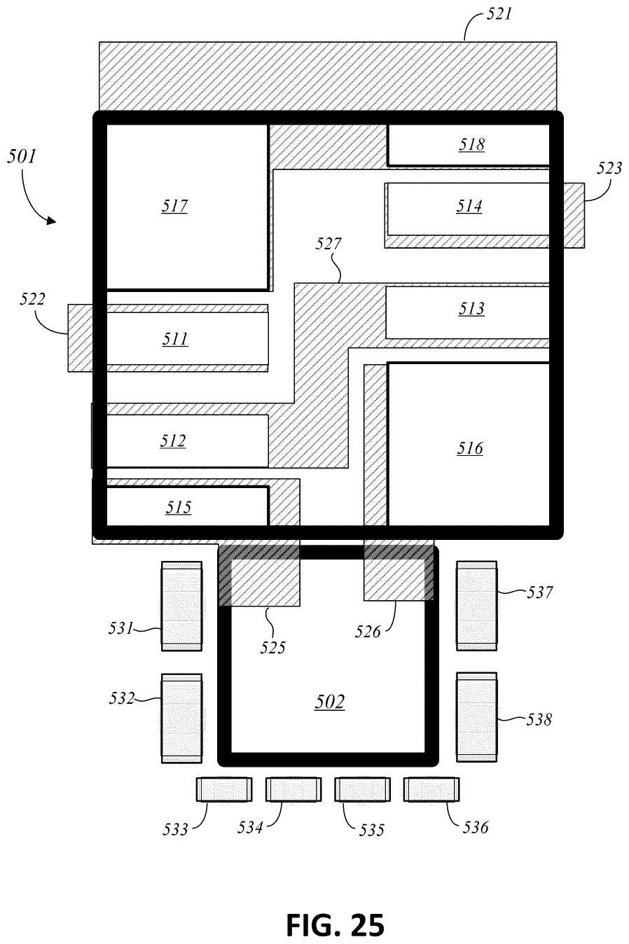

FIG. 25 shows a top view of the TR block 500, in accordance with an embodiment of the present invention. FIG. 25 illustrates an example connection between the transformer module 501 and the rectifier module 502. In the example of FIG. 25, an interconnect 521 connects the pads 517 and 518 to the output voltage VOUT. An interconnect 522 connects the pad 511 to a previous transformer module 501 in a chain of transformer modules 501, and an interconnect 523 connects the pad 514 to a next transformer module 501 in the chain of transformer modules 501. An interconnect 525 connects the pad 515 to the first end of the rectifier 121 in the rectifier module 502, and an interconnect 526 connects the pad 516 to the first end of the rectifier 122 in the rectifier module 502. An interconnect 527 connects the pad 512 to the pad 513. Various electronic components 531-538 may be mounted in the vicinity of the rectifier module 502. These components may include coupling capacitors, resistors, power transistors, integrated circuits, etc.

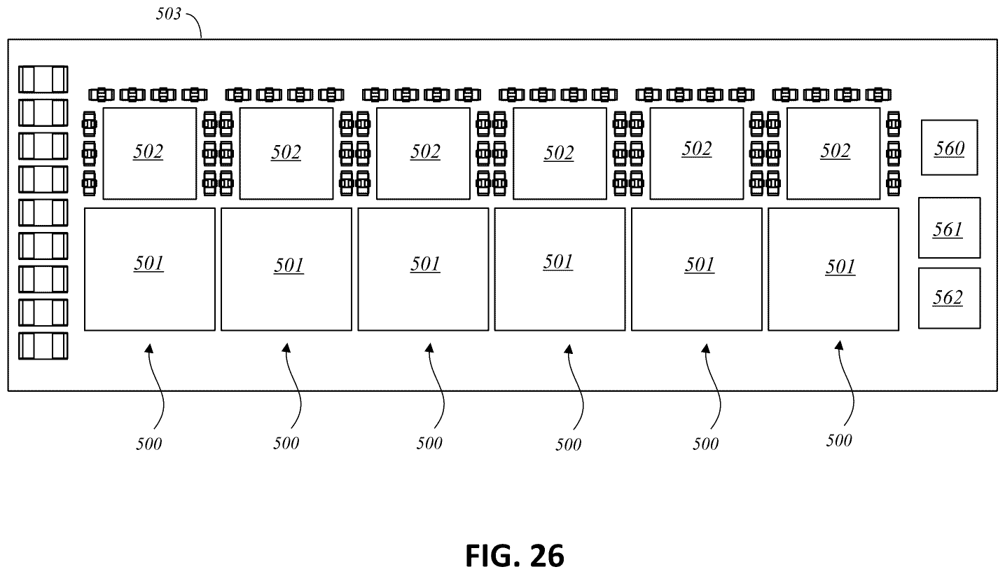

FIG. 26 shows a top view of horizontally disposed TR blocks, in accordance with an embodiment of the present invention. In the example of FIG. 26, 6 TR blocks 500 are mounted on a surface of the substrate 503, with each TR block 500 comprising a transformer module 501 and a rectifier module 502. The transformer modules 501 and rectifier modules 502 are disposed in horizontal fashion, side by side on the substrate 503. A bridge circuit (not shown) may be mounted on the substrate 503 or another substrate.

FIG. 26 also shows other electronic components that are mounted on the substrate 503, such as components 560 (e.g., a gate driver IC), 561 (e.g., a high voltage (e.g., 80V) Field Effect Transistor (FET)), and 562 (e.g., another high voltage FET). Other electronic components on the substrate 503 are not labeled for clarity of illustration.

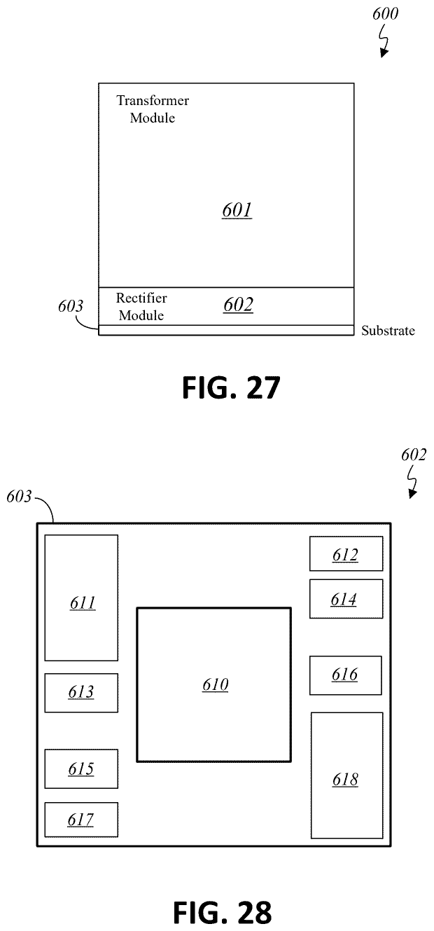

FIG. 27 shows a front view of a TR block 600, in accordance with an embodiment of the present invention. The TR block 600 comprises a transformer module 601 and a rectifier module 602. The transformer module 601 and the rectifier module 602 are vertically stacked one on top of another. In the example of FIG. 27, the rectifier module 602 is mounted on a surface of a substrate 603 (e.g., PCB), and the transformer module 601 is mounted on top of the rectifier module 602. Each TR block 600 may have its own substrate 603. A plurality of TR blocks 600 may also share the same substrate 603. In one embodiment, the transformer module 601 comprises the previously described transformer T1 or T2, and the rectifier module 602 comprises the previously described rectifier circuit 130.

FIG. 28 shows a top view of the rectifier module 602, in accordance with an embodiment of the present invention. In the example of FIG. 28, the rectifier module 602 comprises an integrated circuit (IC) die 610 in which the rectifiers 121 and 122 are fabricated. The IC die 610 may have a copper sink (not shown) on its topmost surface for heat dissipation and for accepting a soldering pad that facilitates attachment of a heat sink. The IC die 610 is mounted on the substrate 603.

Pads 611-618, which are formed on the substrate 603, are connected by interconnects (not shown) to corresponding nodes and/or pads as per the connections shown in FIGS. 1-4. In the example of FIG. 28, the pads 611 and 612 connect to the output voltage VOUT; the pad 613 is connected to the node 1, which is connected to an end of the series-connected primary windings L11 and L12; the pad 614 is connected to the node 4, which is connected to the other end of the series-connected primary windings L11 and L12; the pad 615 is connected to the node 2; the pad 616 is connected to the node 3; the pad 617 is connected to the first end of the rectifier 121; and the pad 618 is connected to the first end of the rectifier 122.

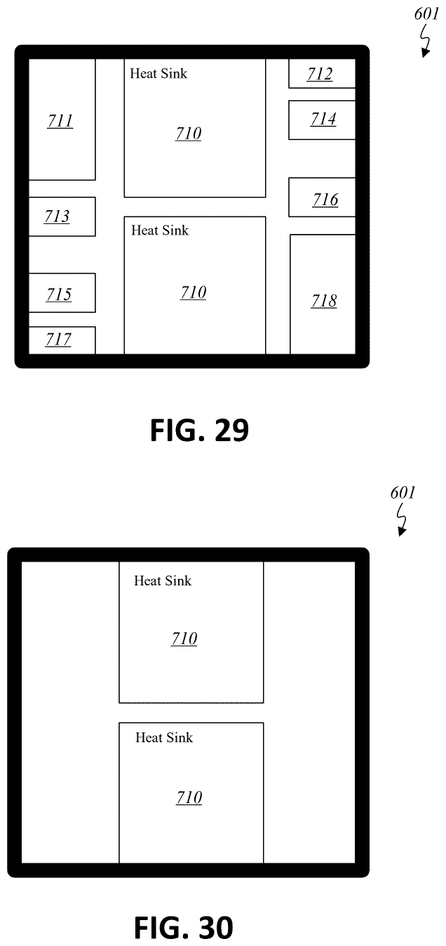

FIG. 29 shows a top view of the bottom surface of the transformer module 601, in accordance with an embodiment of the present invention. FIG. 29 shows the bottom surface (as viewed from the top) of the transformer module that will interface with the rectifier module 602 as shown in FIG. 28. More particularly, the pads 711-718 are connected to the pads 611-618, respectively. The transformer module 601 further includes heat sinks 710 that are attached to the IC die 610 for heat dissipation. In one embodiment, the heat sinks 710 are attached to bare copper on a top surface of the IC die 610.

FIG. 30 shows a top view of the transformer module 601, in accordance with an embodiment of the present invention. FIG. 30 shows the heat sinks 710 as protruding to be visible on the top of the transformer module 601.

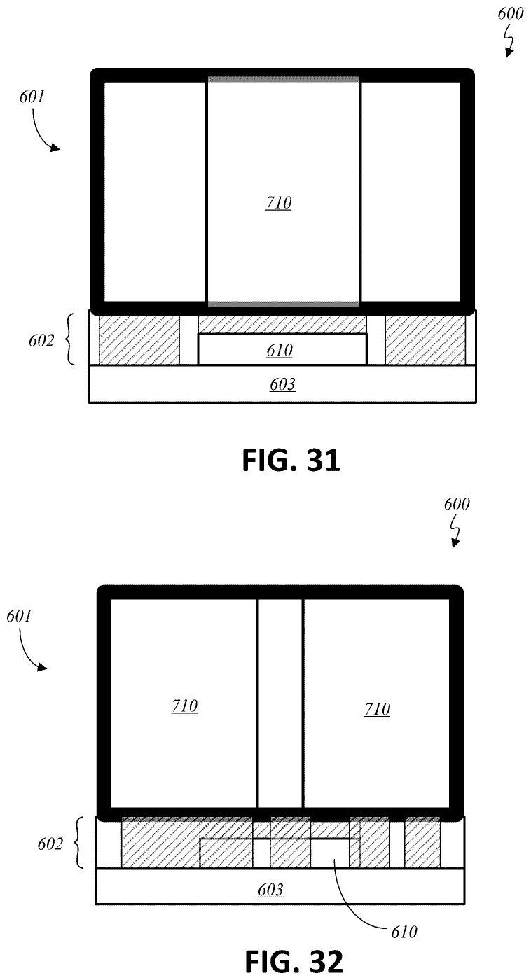

FIGS. 31 and 32 show front views of the TR block 600, in accordance with an embodiment of the present invention. In the example of FIGS. 31 and 32, hashed elements represent metal structures, such as copper interconnects. The interconnects may connect pads of the rectifier module 602 to corresponding pads of the transformer module 601. The IC die 610 may be attached to the heat sinks 710 by way of a metal layer, for example. The transformer T1 or T2 (not shown) may be disposed on the bottom surface or other available space of the transformer module 601.

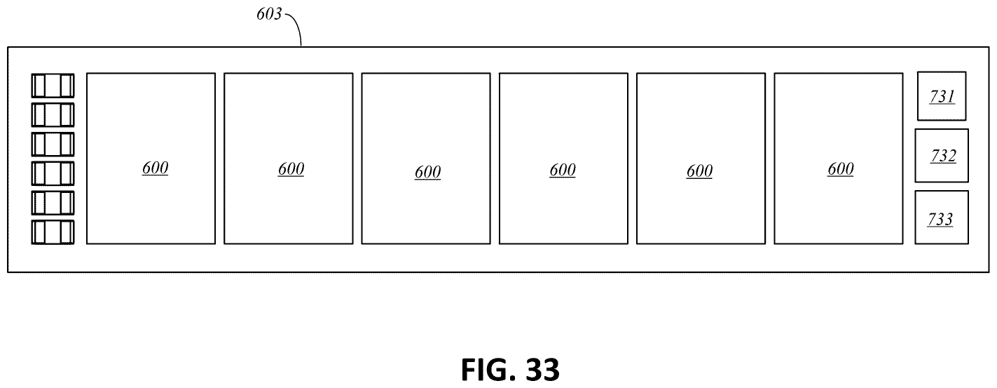

FIG. 33 shows a top view of TR blocks 600, in accordance with an embodiment of the present invention. In the example of FIG. 33, 6 TR blocks 600 are mounted on a surface of the substrate 603. FIG. 33 further shows other electronic components that are mounted on the substrate 603, such as components 731 (e.g., a gate driver IC), 732 (e.g., a high voltage (e.g., 80V) FET), and 733 (e.g., another high voltage FET). Other electronic components on the substrate 603 are not labeled for clarity of illustration. A bridge circuit (not shown) may be mounted on the substrate 603 or another substrate.

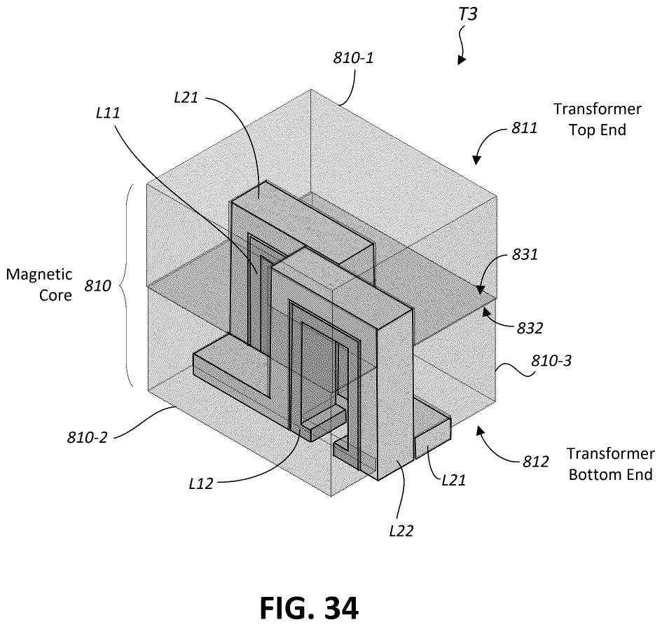

FIG. 34 shows a transparent, perspective view of a transformer T3, in accordance with an embodiment of the present invention. The transformer T3 may be used as a transformer in TR blocks disclosed herein. The transformer T3 has a bottom end 812 and a top end 811. “Top” and “bottom” are relative to a substrate that supports the transformer T3. In one embodiment, the bottom end 812 is mounted on a surface of a PCB or other substrate.

The transformer T3 comprises a magnetic core 810 and the previously described primary windings L12 and L11 and secondary windings L21 and L22. As before, the secondary winding L21 is wound over the primary winding L11 and the secondary winding L22 is wound over the primary winding L12. The primary winding L11, primary winding L12, secondary winding L21, and secondary winding L22 may be flat copper wires with enamel coating.

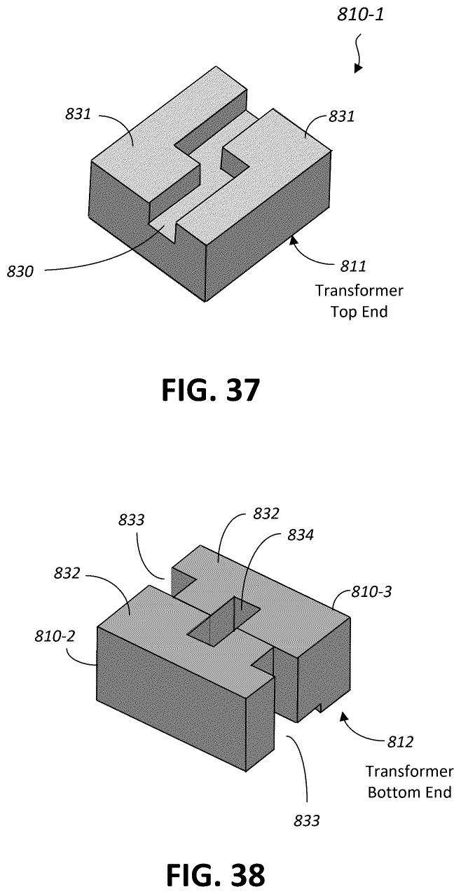

The magnetic core 810 houses the primary windings L12 and L11 and secondary windings L21 and L22. The magnetic core 810 may be a single-piece or multipiece core that is made of a magnetic material that is commonly-used in magnetic cores. In one embodiment, the magnetic core 810 is a multipiece core comprising magnetic core portions 810-1, 810-2, and 810-3. The magnetic core portions 810-2 and 810-3 are joined together to form a bottom most surface at the bottom end 812. The magnetic core portion 810-1 is disposed on top of the magnetic core portions 810-2 and 810-3 to form a topmost surface at the top end 811. The magnetic core portion 810-1 has an interface surface 831 (shown also in FIG. 37) that mates with an interface surface 832 (shown also in FIG. 38) of the magnetic core portions 810-2 and 810-3.

In contrast to the transformers T1 (see FIG. 6) and T2 (see FIG. 14), the leakage flux path in the transformer T3 is not through the center leg of the magnetic core. Instead, the leakage flux path is through the magnetic core 810 on top of the windings. Flowing leakage flux through the magnetic core on top of the windings advantageously allows the windings to be disposed closer to each other, thereby reducing the footprint of the transformer T3 and allowing for flux cancellation and lower AC winding loss.

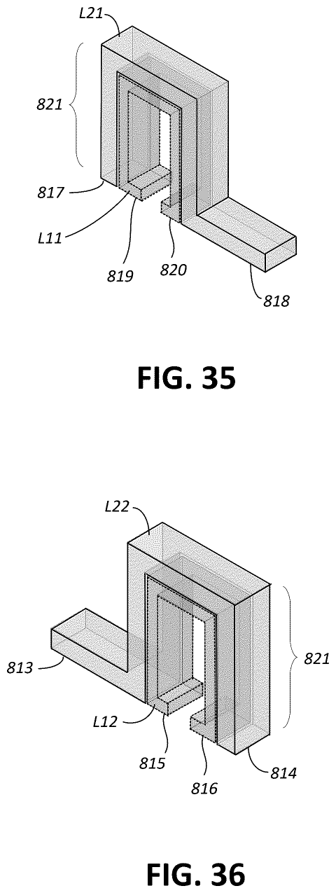

FIG. 35 shows a perspective view of the primary winding L11 and secondary winding L21 of the transformer T3, and FIG. 36 shows a perspective view of the primary winding L12 and the secondary winding L22 of the transformer T3, in accordance with an embodiment of the present invention. In the example of FIGS. 35 and 36, each of the primary winding L11, primary winding L12, secondary winding L21, and secondary winding L22 is wound 1 turn. In general, in the transformer T3, each of the primary windings L11 and L12 may be wound one or more turns, and each of the secondary windings L21 and L22 is wound 1 turn.

The primary winding L11, primary winding L12, secondary winding L21, and secondary winding L22 are further labeled in FIGS. 35 and 36 to facilitate illustration of an example pad arrangement, i.e., pinout (shown in FIG. 40). Referring to FIG. 35, ends 819 and 820 of the primary winding L11 and ends 817 and 818 of the secondary winding L21 may be electrically connected to circuit nodes from the bottom end 812 of the transformer T3. The secondary winding L21 is wound over the primary winding L11. Similarly, referring to FIG. 36, ends 815 and 816 of the primary winding L12 and ends 813 and 814 of the secondary winding L22 may be electrically connected to circuit nodes from the bottom end 812 of the transformer T3. The secondary winding L22 is wound over the primary winding L12. Portions of the windings L11, L12, L21, and L22 (see FIGS. 35 and 36, 821) extend toward the top end 811 of the transformer T3.

FIG. 37 shows a perspective view of the magnetic core portion 810-1, in accordance with an embodiment of the present invention. The magnetic core portion 810-1 is shown in an inverted orientation to highlight a channel 830 formed on its interface surface 831. The top end 811 of the transformer T3 is opposite the interface surface 831. The channel 830 is a recess in the magnetic core portion 810-1 for receiving portions of the secondary windings L21 and L22 that extend into the magnetic core portion 810-1 toward the top end 811 of the transformer T3. Depending on physical dimensions, the channel 830 may also receive portions of the primary windings L11 and L12 that extend into the magnetic core portion 810-1 toward the top end 811 of the transformer T3.

The magnetic core portion 810-1 may be a single-piece core, with the interface surface 831 configured to mate with the interface surface 832 (shown in FIG. 38) of the magnetic core portions 810-2 and 810-3. The channel 830 may receive portions of the secondary and primary windings, allowing the magnetic core portion 810-1 to be positioned on top of the magnetic core portions 810-2 and 810-3 to provide a top leakage flux path.

FIG. 38 shows a perspective view of the magnetic core portions 810-2 and 810-3, in accordance with an embodiment of the present invention. The magnetic core portions 810-2 and 810-3 have the interface surface 832, which mates with the interface 831 of the magnetic core portion 810-1. The interface surface 832 is opposite the bottom end 812 of the transformer T3.

Each of the magnetic core portions 810-2 and 810-3 may be a single-piece core. A winding window 834 and notches 833 are formed when the magnetic core portions 810-2 and 810-3 are joined. The winding window 834 is open all the way through. The windings L11, L12, L21, and L22 are received in the notches 833 and wound around magnetic core material (i.e., of the magnetic core 810) through the winding window 834.

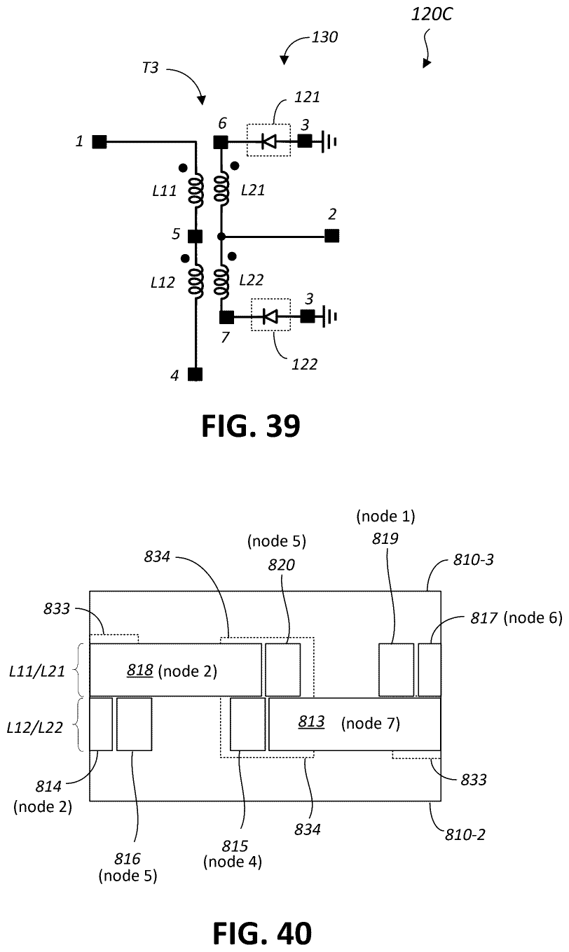

FIG. 39 shows a schematic diagram of a TR block 120C, in accordance with an embodiment of the present invention. The TR block 120C comprises the transformer T3 and the rectifier circuit 130. The TR block 120C is an embodiment of the TR block 120 where the transformer T1 is replaced with the transformer T3; TR blocks 120 and 120C are otherwise the same. Nodes 1-4 are as previously described. In FIG. 39, nodes 5, 6, and 7 are labeled for reference in the discussion of FIG. 40.

FIG. 40 shows a bottom view of the transformer T3, in accordance with an embodiment of the present invention. In the example of FIG. 39, the primary winding L12 and secondary winding L22 are wound around the magnetic core portion 810-2, whereas the primary winding L11 and secondary winding L21 are wound around the magnetic core portion 810-3. The general location of the winding window 834 and notches 833 are noted for reference. The ends 813-820 (also shown in FIGS. 35 and 36) are exposed on the bottom end 812 of the transformer T3.

An example pad arrangement of the transformer T3 is now discussed with reference to FIGS. 39 and 40. In one embodiment, the transformer T3 is electrically connected to the rectifier circuit 130 as follows:
(a) the end 818 of the secondary winding L21 and the end 814 of the secondary winding L22 are both electrically connected to the node 2;
(b) the end 820 of the primary winding L11 and the end 816 of the primary winding L12 are both electrically connected to the node 5;
(c) the end 817 of the secondary winding L21 is electrically connected to the node 6;
(d) the end 819 of the primary winding L11 is electrically connected to the node 1;
(e) the end 815 of the primary winding L12 is electrically connected to the node 4; and
(f) the end 813 of the secondary winding L22 is electrically connected to the node 7.

Generally, electrical connections between transformer windings and nodes of a rectifier circuit may be made, for example, by way of traces of the PCB on which the transformer and rectifiers circuit are mounted.

As can be appreciated, the physical configuration of the transformer T3 allows the primary winding L11/secondary winding L21 pair to be disposed adjacent and very close to the primary winding L12/secondary winding L22 pair, without any magnetic core in between. In any event, the close proximity of the primary winding/secondary winding pairs and the presence of relatively large amount of magnetic core on the top of the windings allows for the vast majority of leakage flux to flow through the top of the transformer T3. This advantageously results in flux cancellation and low AC winding loss.

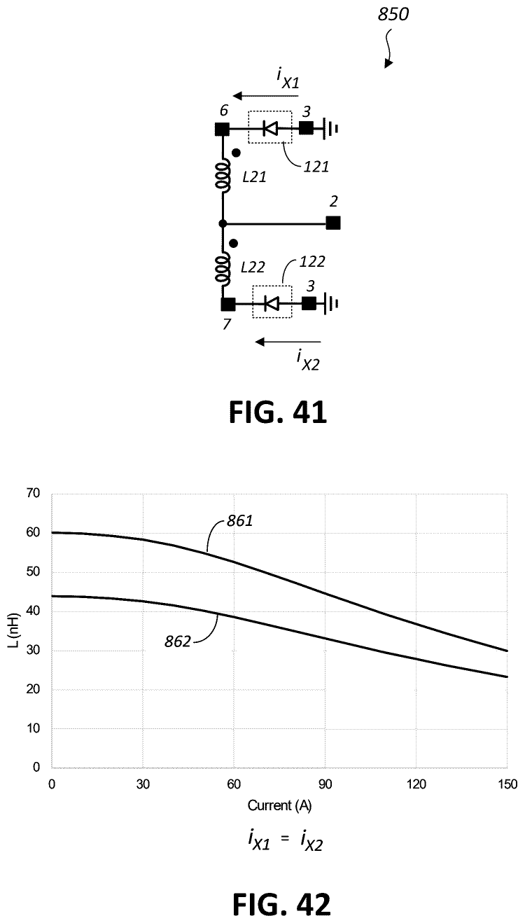

FIG. 41 shows a schematic diagram of a simulation circuit 850, in accordance with an embodiment of the present invention. The simulation circuit 850 is the same as the TR block 120C of FIG. 39, but with the primary windings L11 and L12 physically removed from the transformer T3. Removal of the primary windings L11 and L2 for simulation purposes allows for clearer evaluation of coupling between transformer windings of the transformer T3.

FIG. 42 shows inductance-current (L-I) curves of the secondary windings L21 and L22 of the simulation circuit 850 in a simulation. In FIG. 42, the vertical axis represents inductance. The horizontal axis represents current through the rectifier 121 from anode to cathode (See FIG. 41, i_{X1}), which is the same as the current through the rectifier 122 from anode to cathode (see FIG. 41, i_{X2}). Each of the secondary winding L21 and secondary winding L22 has a single turn in the simulation. In FIG. 42:
(a) the L-I curve 861 is for the self-inductance of the secondary winding L21; and
(d) the L-I curve 862 is for the mutual-inductance of the secondary winding L21 and secondary winding L22.

The L-I curves 861 and 862 show a coupling coefficient of about 25% between the secondary windings L21 and L22. This indicates that configuring the leakage flux to flow through the top of the transformer T3 does not negatively affect magnetic characteristics.

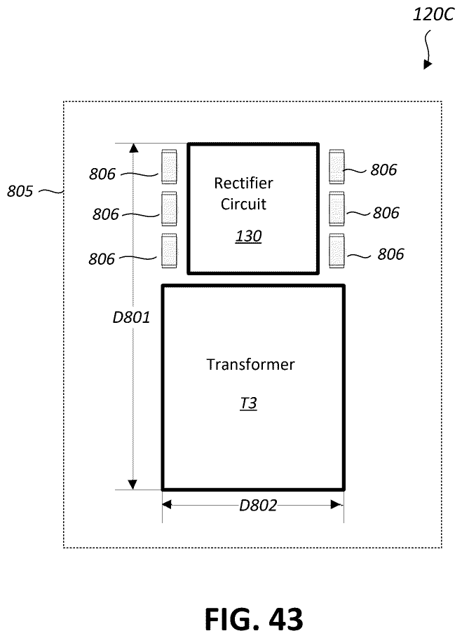

FIG. 43 shows a top view of the TR block 120C, in accordance with an embodiment of the present invention. FIG. 43 illustrates an example physical layout where the transformer T3 and the rectifier circuit 130 are implemented as separate modules that are disposed horizontally side by side on a surface of a substrate 805 (e.g., PCB). Electrical connections between the transformer T3 and the rectifier circuit 130 may be made by way of interconnects (e.g., traces) of the substrate 805. A plurality of TR blocks 120C may be mounted on the same or separate substrates 805. Various electronic components 806 (e.g., capacitors, inductors, resistors) of the power converter that incorporates the transformer T3 and rectifier circuit 130 may be mounted on the substrate 805. The top leakage flux path of the transformer T3 minimizes the footprint of the TR block 120C. In one embodiment, the TR block 120C has a width D802 of 7.00 mm and a length D801 of 13.40 mm.

The relatively small physical dimensions of the transformer T3 allows for a large number of TR blocks 120C to be employed in applications with tight space constraints.

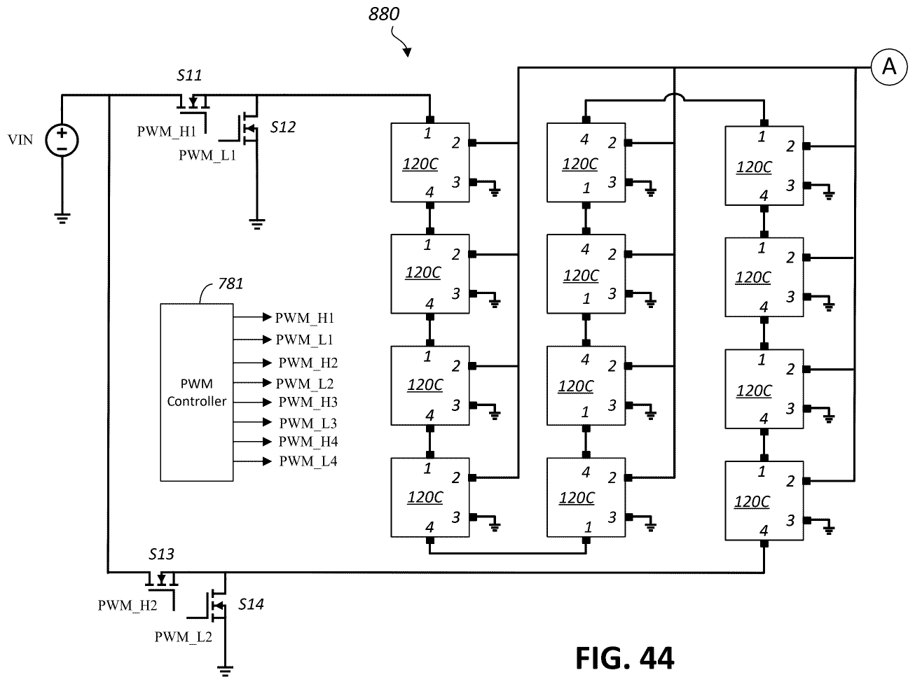

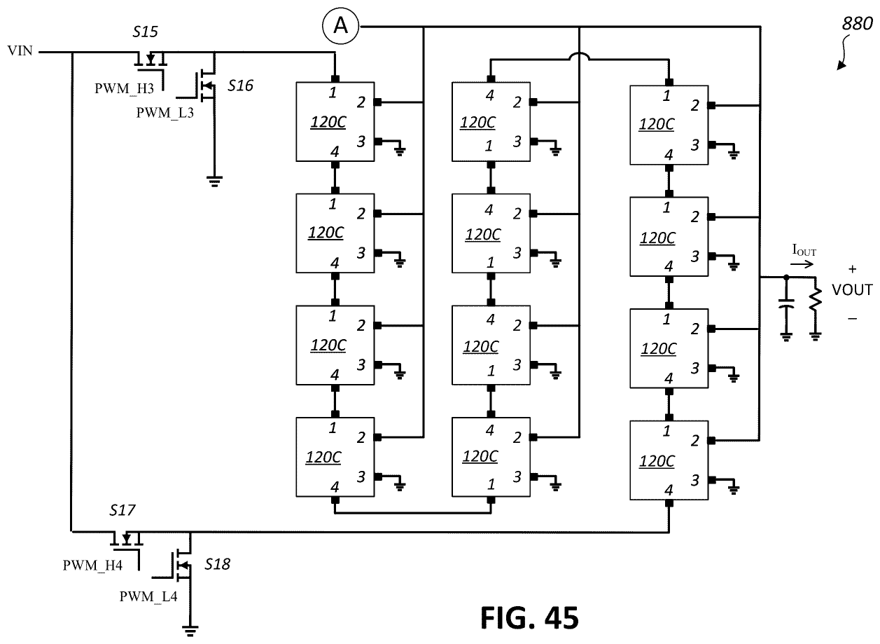

FIGS. 44 and 45 show a schematic diagram of a power converter 880, in accordance with an embodiment of the present invention. The power converter 880 comprises a plurality of TR blocks 120C, each with nodes 1-4 as shown in FIG. 39. In one embodiment, the power converter 880 has 24 TR blocks 120C that are arranged in sets of 12. A first set of 12 TR blocks 120C are electrically connected to form a first chain of TR blocks 120C that are shown in FIG. 44, and a second set of 12 TR blocks 120C are electrically connected as a second chain of TR blocks 120C that are shown in FIG. 45.

The primary windings of the TR blocks 120C in each chain are electrically connected in series. Each chain is driven by a separate full bridge circuit. More particularly, TR blocks in the first chain are driven by a full bridge circuit comprising switches 511, 512, 513, and S14 that receive corresponding control signals PWM_H1, PWM_L1, PWM_H2, and PWM_L2. TR blocks in the second chain are driven by another full bridge circuit comprising switches S15, S16, S17, and S18 that receive corresponding control signals PWM_H3, PWM_L3, PWM_H4, and PWM_L4. The switches S11-S18 may comprise MOSFETS. The PWM controller 781 may generate the control signals PWM_H1, PWM_H2, PWM_H3, PWM_H4, PWM_L1, PWM_L2, PWM_L3, and PWM_L4 in accordance with a suitable PWM control scheme, such as by symmetric full bridge control (SFB) or phase shift full bridge (PSFB) control. The output currents of all the TR blocks 120C are connected in parallel to generate the output current Iout, which is delivered to the load.

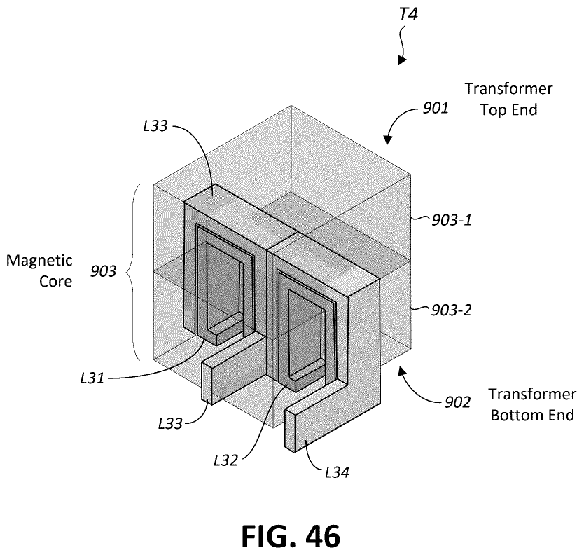

FIG. 46 shows a transparent, perspective view of a transformer T4, in accordance with an embodiment of the present invention. The transformer T4 may be used as a transformer in TR blocks disclosed herein. The transformer T4 has a bottom end 902 and a top end 901. “Top” and “bottom” are relative to a substrate that supports the transformer T4. In one embodiment, the bottom end 902 is mounted on a surface of a PCB or other substrate.

The transformer T4 comprises a magnetic core 903, primary winding L31, primary winding L32, secondary winding L33, and secondary winding L34. The primary winding L31 pairs with secondary winding L33, and the primary winding L32 pairs with the secondary winding L34. As in other primary-secondary winding pairs disclosed herein, the secondary winding L33 is wound over the primary winding L31 and the secondary winding L34 is wound over the primary winding L32. The primary winding L31, primary winding L32, secondary winding L33, and secondary winding L34 may be flat copper wires with enamel coating. In one embodiment, the winding pair L31/L33 and the winding pair L32/L34 have identical physical structures. In the example of FIG. 46, the winding pair L31/L33 and the winding pair L32/L34 are disposed directly adjacent to each other, with insignificant or no magnetic core material between them.

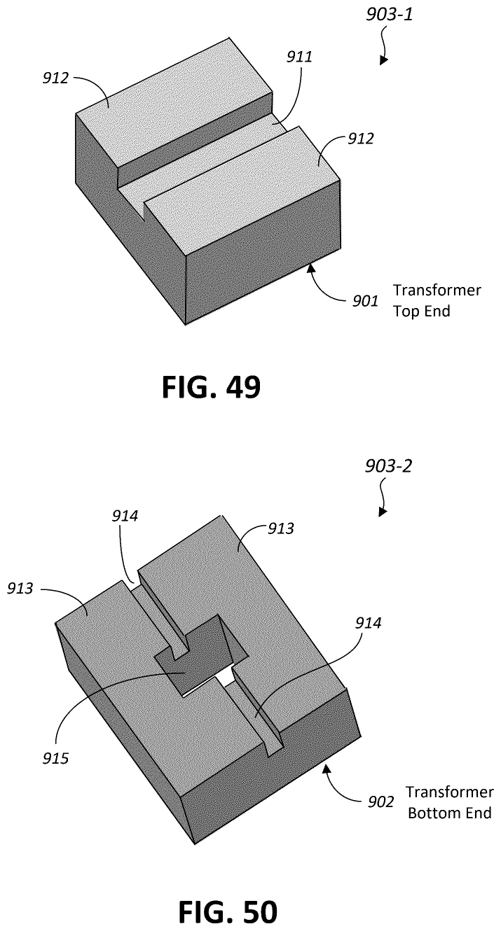

The magnetic core 903 houses the primary winding L31, primary winding L32, secondary winding L33, and secondary winding L34. The magnetic core 903 may be a single-piece or multipiece core that is made of a magnetic material that is commonly-used in magnetic cores. In one embodiment, the magnetic core 903 is a multipiece core comprising magnetic core portions 903-1 and 903-2. The magnetic core portion 903-1 is disposed on top of the magnetic core portion 903-2 and provides a topmost surface at the top end 901. An interface surface of the magnetic core portion 903-1 (shown in FIG. 49, 912) mates with an interface surface of the magnetic core portion 903-2 (shown in FIG. 50, 913).

Similar to the transformer T3, the leakage flux path in the transformer T4 is through the magnetic core 903 on top of the windings.

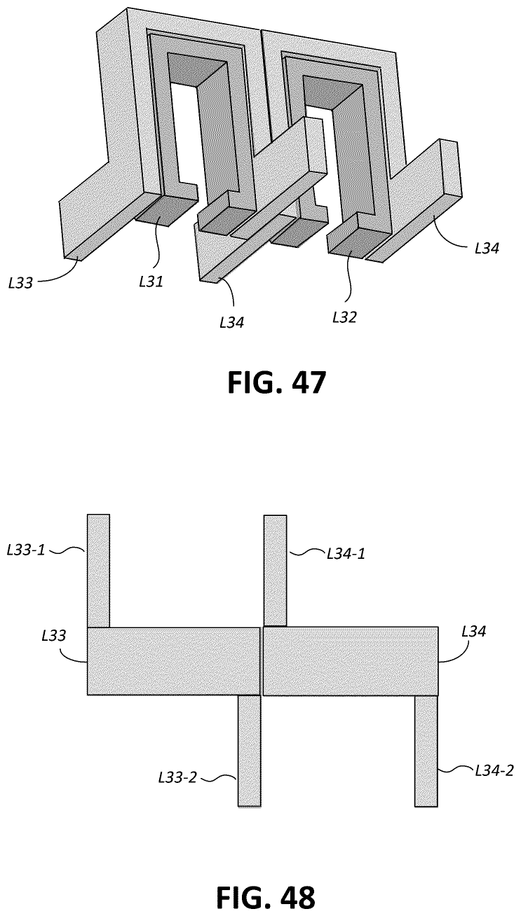

FIG. 47 shows a perspective view of the primary winding L31, primary winding L32, secondary winding L33, and secondary winding L34, in accordance with an embodiment of the present invention.

FIG. 48 shows a top view of the secondary windings L33 and L34, in accordance with an embodiment of the present invention. In the example of FIG. 48, the primary windings L31 and L32 (not shown) are underneath the secondary windings L33 and L34, respectively. The primary windings L31/32 are generally the same as the primary windings L11/L12. The secondary windings L33/34 are generally the same as the secondary windings LL21/L22 except that the secondary windings L33/34 each has two extensions that go in opposite directions. More particularly, the secondary winding L33 has an extending portion L33-1 that extends toward one direction and an extending portion L33-2 that extends toward the opposite direction, and the secondary winding L34 has an extending portion L34-1 that extends toward one direction and an extending portion L34-2 that extends toward the opposite direction.

FIG. 49 shows a perspective view of the magnetic core portion 903-1, in accordance with an embodiment of the present invention. The magnetic core portion 903-1 is shown in an inverted orientation to highlight a channel 911 formed on its interface surface 912. The top end 901 of the transformer T4 is opposite the interface surface 912. The channel 911 is a recess in the magnetic core portion 903-1 for receiving portions of the secondary windings L33 and L34 that extend into the magnetic core portion 903-1 toward the top end 901 of the transformer T4. Depending on physical dimensions, the channel 911 may also receive portions of the primary windings L31 and L32 that extend into the magnetic core portion 903-1 toward the top end 901 of the transformer T4.

The magnetic core portion 903-1 may be a single-piece core, with the interface surface 912 configured to mate with the interface surface 913 (shown in FIG. 50) of the magnetic core portion 903-2. The channel 911 may receive portions of the secondary and primary windings, allowing the magnetic core portion 903-1 to be positioned on top of the magnetic core portion 903-2 to provide a top leakage flux path.

FIG. 50 shows a perspective view of the magnetic core portion 903-2, in accordance with an embodiment of the present invention. The magnetic core portion 903-2 has the interface surface 913, which mates with the interface 912 of the magnetic core portion 903-1. The interface surface 913 is opposite the bottom end 902 of the transformer T4.

The magnetic core portion 903-2 may be a single-piece core, with a winding window 915 and channels 914. The winding window 915 is open all the way through. The windings L31, L32, L33, and L34 are wound around magnetic core material (i.e., of the magnetic core 903) through the winding window 915. Extending portions of the secondary windings L33 and L34 are received in the channels 914.

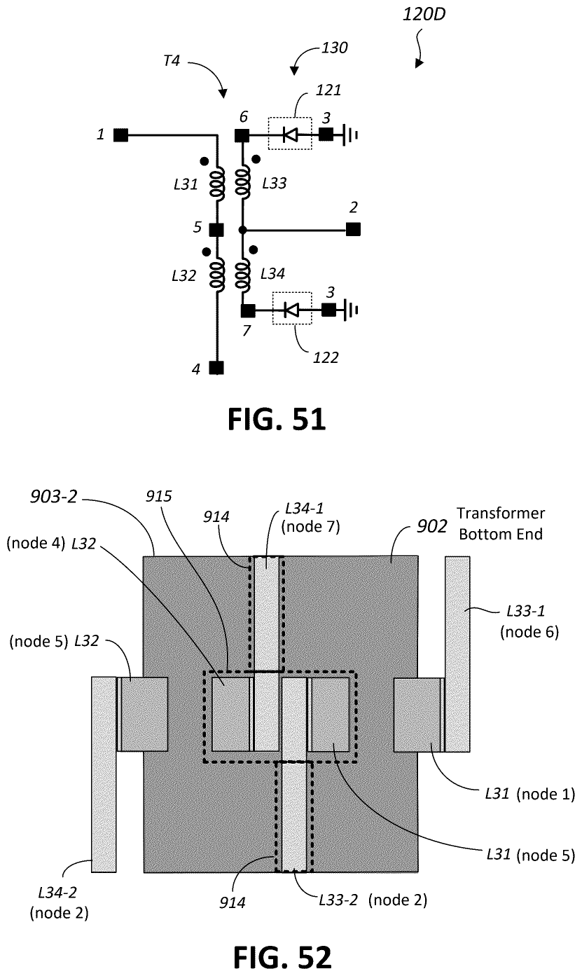

FIG. 51 shows a schematic diagram of a TR block 120D, in accordance with an embodiment of the present invention. The TR block 120D comprises the transformer T4 and the rectifier circuit 130. The TR block 120D is an embodiment of the TR block 120 where the transformer T1 is replaced with the transformer T4; the TR blocks 120 and 120D are otherwise the same. Nodes 1-4 are as previously described. In FIG. 51, nodes 5, 6, and 7 are labeled for reference in the discussion of FIG. 52.

FIG. 52 shows a bottom view of the transformer T4, in accordance with an embodiment of the present invention. The general location of the winding window 915 and channels 914 are indicated for reference purposes.

An example electrical connection of the transformer T4 is now discussed with reference to FIGS. 51 and 52. In one embodiment, the transformer T4 is electrically connected to the rectifier circuit 130 as follows:
(a) the extending portion L33-2 of the secondary winding L33 and the extending portion L34-2 of the secondary winding L34 are both electrically connected to the node 2;
(b) a first end of the primary winding L31 and a first end of the primary winding L32 are both electrically connected to the node 5;
(c) the extending portion L33-1 of the secondary winding L33 is electrically connected to the node 6;
(d) a second end of the primary winding L31 is electrically connected to the node 1;
(e) a second end of the primary winding L32 is electrically connected to the node 4; and
(f) the extending portion L34-1 of the secondary winding L34 is electrically connected to the node 7.

As can be appreciated, the physical configuration of the transformer T4 allows the primary winding L31/secondary winding L33 pair to be disposed directly adjacent to the primary winding L32/secondary winding L34 pair, without any magnetic core in-between. In any event, the close proximity of the primary winding/secondary winding pairs and the presence of relatively large amount of magnetic core on the top of the windings allows for the vast majority of leakage flux to flow through the top of the transformer T4. This advantageously results in flux cancellation and low AC winding loss.

While specific embodiments of the present invention have been provided, it is to be understood that these embodiments are for illustration purposes and not limiting. Many additional embodiments will be apparent to persons of ordinary skill in the art reading this disclosure.

What is claimed is:

1. A transformer-rectifier block for a power converter, the transformer-rectifier block comprising:
a substrate;
a transformer having a bottom end that is mounted on the substrate, the transformer comprising a magnetic core, a first primary winding, a first secondary winding that is wound over the first primary winding, a second primary winding, and a second secondary winding that is wound over the second primary winding, wherein the first and second secondary windings are disposed adjacent to each other, and the magnetic core is disposed over portions of the first and second secondary windings that extend toward a top end of the transformer; and
a rectifier circuit that is mounted on the substrate, the rectifier circuit comprising a first rectifier that is electrically connected to an end of the first secondary winding and a second rectifier that is electrically connected to an end of the second secondary winding.

2. The transformer-rectifier block of claim 1, wherein the magnetic core has a recess and the first secondary winding and the second secondary winding extend toward the top end of the transformer into the recess.

3. The transformer-rectifier block of claim 2, wherein the magnetic core comprises a first magnetic core portion, a second magnetic core portion, and a third magnetic core portion.

4. The transformer-rectifier block of claim 3, wherein the recess is in the first magnetic core portion, and the first magnetic core portion is disposed over the second and third magnetic core portions.

5. The transformer-rectifier block of claim 4, wherein the second and third magnetic core portions form a winding window through which the first primary winding, the second primary winding, the first secondary winding, and the second secondary winding are wound.

6. The transformer-rectifier block of claim 1, wherein there is no magnetic core material between the first secondary winding and the second secondary winding.

7. The transformer-rectifier block of claim 1, wherein the first primary winding, the second primary winding, the first secondary winding, and the second secondary winding each has a single turn.

8. A transformer for a power converter, the transformer comprising:
a plurality of windings comprising a first primary winding, a first secondary winding that is wound over the first primary winding, a second primary winding, and a second secondary winding that is wound over the second primary winding; and
a magnetic core that is disposed over the first primary winding, the second primary winding, the first secondary winding, and the second secondary winding,
wherein the first and second secondary windings are disposed adjacent to each other, and the first primary winding, the first secondary winding, the second primary winding, and the second secondary winding extend toward a top end of the transformer into a recess in the magnetic core.

9. The transformer of claim 8, wherein a bottom end of the transformer is mounted on a substrate.

10. The transformer of claim 9, wherein the substrate is a printed circuit board (PCB).

11. The transformer of claim 8, wherein the magnetic core comprises a first magnetic core portion, a second magnetic core portion, and a third magnetic core portion.

12. The transformer of claim 11, wherein the first magnetic core portion is disposed over the first and second magnetic core portions.

13. The transformer of claim 12, wherein the first secondary winding and the second secondary winding extend into the recess of the first magnetic core portion.

14. The transformer of claim 12, wherein the second and third magnetic core portions form a winding window through which the first primary winding, the second primary winding, the first secondary winding, and the second secondary winding are wound.

15. The transformer of claim 12, wherein there is no magnetic core material between the first secondary winding and the second secondary winding.

16. The transformer of claim 12, wherein the first primary winding, the second primary winding, the first secondary winding, and the second secondary winding each has a single turn.

17. A power converter comprising:
a bridge circuit; and
a plurality of transformer-rectifier (TR) blocks, each of the TR blocks comprising a rectifier and a transformer, the transformer comprising a plurality of windings and a magnetic core that is disposed over the windings, the windings are disposed adjacent to each other and extend toward a top end of the transformer into a recess in the magnetic core,
wherein primary windings of transformers of the TR blocks are connected in series to receive a current from the bridge circuit, and output currents of the TR blocks flow from secondary windings of the transformers of the TR blocks to a load.

18. The power converter of claim 17, wherein there is no magnetic core material between secondary windings of each transformer of each of the TR blocks.

19. The power converter of claim 17, wherein bottom ends of the transformers of the TR blocks are mounted on a substrate.

20. The power converter of claim 17, wherein the bridge circuit is a full bridge circuit.
